(19) United States
(12) Patent Application Publication
(10) Pub. No.: US 2025/0372045 A1
(43) Pub. Date: Dec. 4, 2025

(54) DRIVING CIRCUIT AND ELECTRONIC DEVICE COMPRISING THE SAME

(71) Applicant: Samsung Display Co., Ltd., Yongin-Si (KR)

(72) Inventors: Junhyun Park, Yongin-si (KR); Youngwan Seo, Yongin-si (KR); Soil Yoon, Yongin-si (KR)

(21) Appl. No.: 19/220,659

(22) Filed: May 28, 2025

(30) Foreign Application Priority Data
May 31, 2024 (KR) 10-2024-0071784

(51) Int. Cl. G09G 3/3266

(52) U.S. Cl. CPC G09G 3/3266; G09G 2310/0286; G09G 2310/08

(57) ABSTRACT

According to one or more embodiments, a driving circuit includes a plurality of stage groups and each of the plurality of stage groups includes a control stage and a plurality of output stages connected to the control stage. The control stage controls voltages of a first node and a second node, and each of the plurality of output stages is connected to the first node and the second node to share the control stage and outputs an output signal according to the voltages of the first node and the second node.

### CROSS-REFERENCE TO RELATED APPLICATION

This application is based on and claims priority under 35 U.S.C. § 119 to Korean Patent Application No. 10-2024-0071784, filed on May 31, 2024, in the Korean Intellectual Property Office, the disclosure of which is incorporated by reference herein in its entirety.

### BACKGROUND

### 1. Field

One or more embodiments relate to a driving circuit, and a display device and an electronic device including the driving circuit.

### 2. Description of the Related Art

A display device includes a pixel area including a plurality of pixels, a gate driving circuit, a data driving circuit, a controller, and the like. The gate driving circuit includes stages connected to gate lines, and the stages supply gate signals to the gate lines connected to the stages in response to signals from the controller.

### SUMMARY

One or more embodiments include a driving circuit capable of outputting gate signals stably and a display device including the driving circuit. The technical problems to be achieved by the disclosure are not limited to the technical problems mentioned above, and other technical problems not mentioned may be clearly understood by those skilled in the art from the description of the disclosure.

Additional aspects will be set forth in part in the description which follows and, in part, will be apparent from the description, or may be learned by practice of the presented embodiments of the disclosure.

According to one or more embodiments, a driving circuit includes a plurality of stage groups and each of the plurality of stage groups may include a control stage and a plurality of output stages connected to the control stage. The control stage may be connected to a first terminal which supplies a first voltage and a second terminal which supplies a second voltage having a different level from a level of the first voltage, and may control voltages of a first node and a second node. Each of the plurality of output stages may be connected to the first node, and the second node to share the control stage, and may output an output signal through an output terminal according to the voltages of the first node and the second node. The control stage may include a first transistor connected to an input terminal which supplies a start signal, and the first node, and having a gate connected to a first clock terminal which supplies one of a plurality of clock signals. Each of the plurality of output stages may include a second transistor connected to the first node and a third node, and having a gate connected to the second terminal, and a third transistor connected to the output terminal and a second clock terminal which supplies another one of the plurality of clock signals, and having a gate connected to the third node.

Each of the output stages may further include a fourth transistor connected to the first terminal and the output terminal, and having a gate connected to the second node, a first capacitor connected to the output terminal and the third node, and a second capacitor connected to the s first terminal and the second node.

Each of the output stages may further include a fourth transistor connected to the first terminal and the output terminal, and having a gate connected to the second node, and a first capacitor connected to the output terminal and the third node, and at least one of the output stages may further include a second capacitor connected to the first terminal and the second node.

Each of the plurality of clock signals swings between a first level voltage and a second level voltage which alternate with each other, and when the number of the plurality of output stages is m−1, the plurality of clock signals may include first through m-th clock signals which are phase-shifted by a 1/m period, where the m is a positive integer of 3 or more.

A clock signal input from the second clock terminal may include one of the plurality of clock signals other than a clock signal input from the first clock terminal among the first through m-th clock signals, and clock signals input from second clock terminals of m−1 output stages are sequentially phase-shifted by a 1/m period.

The control stage may further include a fifth transistor connected to the first terminal and the first node, and having a gate connected to the second node, a sixth transistor connected to the fifth transistor and the first node, and having a gate connected to a third clock terminal which supplies one of the plurality of clock signals, a seventh transistor connected to the second node and the first clock terminal, and having a gate connected to the first node, and an eighth transistor connected to the second node and the second terminal, and having a gate connected to the first clock terminal, and a clock signal input from the third clock terminal comprises one of the plurality of clock signals other than a clock signal input from the first clock terminal among the first through m-th clock signals.

One of the plurality of clock signals input from a second clock terminal of the m−1 output stages and the clock signal input from the third clock terminal are same.

The start signal may include an external signal or an output signal output from the last output stage of the previous stage group.

While first-level output signals are sequentially output from the plurality of output stages, a voltage of the second node may be a voltage of a second level in which the first level is inverted.

When the number of the plurality of output stages is m−1, the plurality of clock signals may include m clock signals which are phase-shifted by a 1/m period, and an input order of the m clock signals may be repeated in units of m stage groups, where the m is a positive integer of 3 or more.

The second voltage may be a voltage lower than the first voltage, and transistors included in the control stage and the output stages may include P-channel transistors.

The second voltage may be a voltage higher than the first voltage, and transistors included in the control stage and the output stages may include N-channel transistors.

According to one or more embodiments, a driving circuit includes a plurality of stage groups, and each of the plurality of stage groups may include a control stage and at least two output stages connected to the control stage. The control stage may be connected to an input terminal which supplies a start signal, a first clock terminal which supplies a first clock signal among a plurality of clock signals, and a first terminal which supplies a first voltage, and a second terminal which supplies a second voltage having a different level from a level of the first voltage, and is configured to control voltages of a first node and a second node in response to the start signal and the first clock signal. Each of the at least two output stages may be connected to the first terminal and a second clock terminal which supplies a second clock signal among the plurality of clock signals, and is connected to the first node and the second node to output an output signal of a first level or a second level according to the voltages of the first node and the second node. In each of the plurality of clock signals, a first level voltage and a second level voltage lower than the first level voltage may alternate with each other, and when the number of the at least two output stages is m−1, the plurality of clock signals may include m clock signals which are phase-shifted by a 1/m period, and the m may include a positive integer of 3 or more. The first clock signal may be one of the m clock signals, and the second clock signal may be one of the m clock signals other than the first clock signal among the m clock signals. Second clock signals input from m−1 output stages may be sequentially phase-shifted by a 1/m period.

The control stage may include a first transistor connected to the input terminal and the first node, and having a gate connected to the first clock terminal.

Each of the at least two output stages may include a second transistor connected to the first node and a third node, and having a gate connected to the second terminal, and a third transistor connected to an output terminal outputting the output signal and the second clock terminal, and having a gate connected to the third node.

Each of the at least two output stages may further include a fourth transistor connected to the first terminal and the output terminal, and having a gate connected to the second node, a first capacitor connected to the output terminal and the third node, and a second capacitor connected to the first terminal and the second node.

Each of the at least two output stages may further include a fourth transistor connected to the first terminal and the output terminal, and having a gate connected to the second node, and a first capacitor connected to the output terminal and the third node, and one of the at least two output stages may further include a second capacitor connected to the first terminal and the second node.

The start signal may be an external signal or an output signal output from the last output stage of the previous stage group.

The control stage may include a fifth transistor connected to the first terminal and the first node, and having a gate connected to the second node, a sixth transistor connected to the fifth transistor and the first node, and having a gate connected to a third clock terminal which supplies a third clock signal of the plurality of clock signals, a seventh transistor connected to the second node and the first clock terminal, and having a gate connected to the first node, and an eighth transistor connected to the second node and the second terminal, and having a gate connected to the first clock terminal, and the third clock signal may be one of the m clock signals other than the first clock signal among the m clock signals, and one of third clock signals input from the m−1 output stages and the second clock signal may be the same.

An input order of the m clock signals may be repeated in units of m stage groups.

According to one or more embodiments, an electronic device includes a controller configured to output a plurality of clock signals, a power supply circuit configured to output a reference voltage, and a driving circuit configured to output gate signals based on the plurality of clock signals and the reference voltage. The driving circuit may include includes a plurality of stage groups, and each of the plurality of stage groups may include a control stage and a plurality of output stages connected to the control stage, and the control stage may be connected to a first terminal which supplies a first voltage and a second terminal which supplies a second voltage having a different level from a level of the first voltage, and is configured to control voltages of a first node and a second node, and each of the plurality of output stages may be connected to the first node, and the second node to share the control stage, and is configured to output the gate signals through an output terminal according to the voltages of the first node and the second node. The control stage may include a first transistor connected to an input terminal which supplies a start signal and the first node, and having a gate connected to a first clock terminal which supplies one of the plurality of clock signals, and each of the plurality of output stages may a second transistor connected to the first node and a third node, and having a gate connected to the second terminal, and a third transistor connected to the output terminal and a second clock terminal which supplies another one of the plurality of clock signals, and having a gate connected to the third node.

Each of the output stages may further include a fourth transistor connected to the first terminal and the output terminal, and having a gate connected to the second node, a first capacitor connected to the output terminal and the third node, and a second capacitor connected to the first terminal and the second node.

Each of the output stages may further include a fourth transistor connected to the first terminal and the output terminal, and having a gate connected to the second node, and a first capacitor connected to the output terminal and the third node, and at least one of the output stages may further include a second capacitor connected to the first terminal and the second node.

Each of the plurality of clock signals swings between a first level voltage and a second level voltage which alternate with each other, and when the number of the plurality of output stages is m−1, the plurality of clock signals may include first through m-th clock signals which are phase-shifted by 1/m period, where the m may be a positive integer of 3 or more.

A clock signal input from the second clock terminal may be one of the plurality of clock signals other than a clock signal input from the first clock terminal among the first through m-th clock signals, and clock signals input from second clock terminals of the m−1 output stages may be sequentially phase-shifted by a 1/m period.

The control stage may further include a fifth transistor connected to the first terminal and the first node, and having a gate connected to the second node, a sixth transistor connected to the fifth transistor and the first node, and having a gate connected to a third clock terminal which supplies one of the plurality of clock signals, a seventh transistor connected to the second node and the first clock terminal, and having a gate connected to the first node, and an eighth transistor connected to the second node and the second terminal, and having a gate connected to the first clock terminal, and the clock signal input from the third clock terminal may include one of the plurality of clock signals other than the clock signal input from the first clock terminal among the first through m-th clock signals.

One of the plurality of clock signals input from second clock terminals of the m−1 output stages and the clock signal input from the third clock terminal may be the same.

When the number of the plurality of output stages is m−1, the plurality of clock signals may include m clock signals which are phase-shifted by a 1/m period, where the m is a positive integer of 3 or more, and an input order of the m clock signals may be repeated in units of m stage groups.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view schematically illustrating a driving circuit according to an embodiment;

FIG. 2 is a view schematically illustrating input/output signals of a driving circuit according to an embodiment;

FIG. 3 are views schematically illustrating a stage group according to an embodiment;

FIG. 4 is a view schematically illustrating a control stage and one output stage connected to the control stage of the stage group shown in FIG. 3;

FIG. 5 is a timing diagram for describing driving of the stage of FIG. 4;

FIG. 6 is a timing diagram for describing driving of the stage group of FIG. 3;

FIGS. 7A, 7B, 7C and 7D are views illustrating stage groups according to an embodiment;

FIG. 8 is a view schematically illustrating a stage according to an embodiment;

FIGS. 9 and 10 are views schematically illustrating a stage group according to an embodiment;

FIGS. 11A and 11B are views schematically illustrating a stage according to an embodiment;

FIG. 12 is a view schematically illustrating a stage group according to an embodiment;

FIGS. 13A, 13B, 13C and 13D are views illustrating stage groups according to an embodiment;

FIGS. 14, 15 and 16 are views schematically illustrating a stage according to an embodiment;

FIG. 17 is a view schematically illustrating a stage group according to an embodiment;

FIG. 18 is a timing diagram for describing driving of a stage group including the stage of FIGS. 14 through 16;

FIG. 19 is a view schematically illustrating a display device according to an embodiment; and

FIGS. 20A, 20B and 20C are conceptual views for describing a driving method of a display device according to a driving frequency.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Since various modifications and various embodiments are possible, specific embodiments are illustrated in the drawings and described in detail in the detailed description. Effects and features of the disclosure, and a method of achieving them will be apparent with reference to embodiments described below in detail in conjunction with the drawings. However, the disclosure is not limited to the embodiments disclosed herein, but may be implemented in a variety of forms.

In the following embodiments, the terms “first,” “second,” etc. were used for the purpose of distinguishing one element from other elements, not a limited sense.

In the following embodiments, the singular expression includes a plurality of expressions unless the context is clearly different.

In the following embodiments, the terms such as comprising or having are meant to be the features described in the specification, or the elements are present, and the possibility of one or more other features or elements will be added, is not excluded in advance.

In the drawings, for convenience of explanation, the sizes of elements may be exaggerated or reduced. For example, since the size and thickness of each element shown in the drawings are arbitrarily indicated for convenience of explanation, the disclosure is not necessarily limited to the illustration.

In the present specification, “A and/or B” is A, B, or A and B. In addition, in the present specification, “at least one of A and B” is A, B, or A and B.

In the following embodiments, when X and Y are connected, the case where X and Y are electrically connected and the case where X and Y are functionally connected, may be included. In addition, when X and Y are connected, the case where X and Y are directly connected, and the case where X and Y may be indirectly connected to each other with other elements therebetween may be included. Here, X and Y may be elements (for example, devices, components, circuits, wires, electrodes, terminals, films, layers, regions, etc.). Thus, the disclosure is not limited to a predetermined connection relationship, for example, the connection relationship indicated in the drawings or the detailed description, and may also include other than the connection relationships indicated in the drawings or the detailed description.

For example, the case where X and Y are electrically connected may include the case where X and Y are directly electrically connected, and/or the case where X and Y are indirectly electrically connected with other elements therebetween. When X and Y are indirectly electrically connected, for example, one or more elements (for example, switches, transistors, capacitive elements, inductors, resistance elements, diodes, etc.) enabling electrical connection of X and Y may be connected between X and Y.

In the following embodiment, “ON” used in association with an element state may refer to the activated state of the element, and “OFF” may refer to the deactivated state of the element. “ON” used in connection with a signal received by the element may refer to a signal activating the element, and “OFF” may refer to a signal deactivating the element. The element may be activated by a high level voltage or a low level voltage. For example, a P-channel transistor (P-type transistor) is activated by a low-level voltage, and an N-channel transistor (N-type transistor) is activated by a high-level voltage. Thus, it should be understood that the “ON” voltage for the P-type transistor and the N-type transistor is at opposite (low versus high) voltage levels. Hereinafter, a voltage for activating (turn-on) the transistor is referred to as a gate-on voltage, and a voltage for deactivating (turn-off) the transistor is referred to as a gate-off voltage.

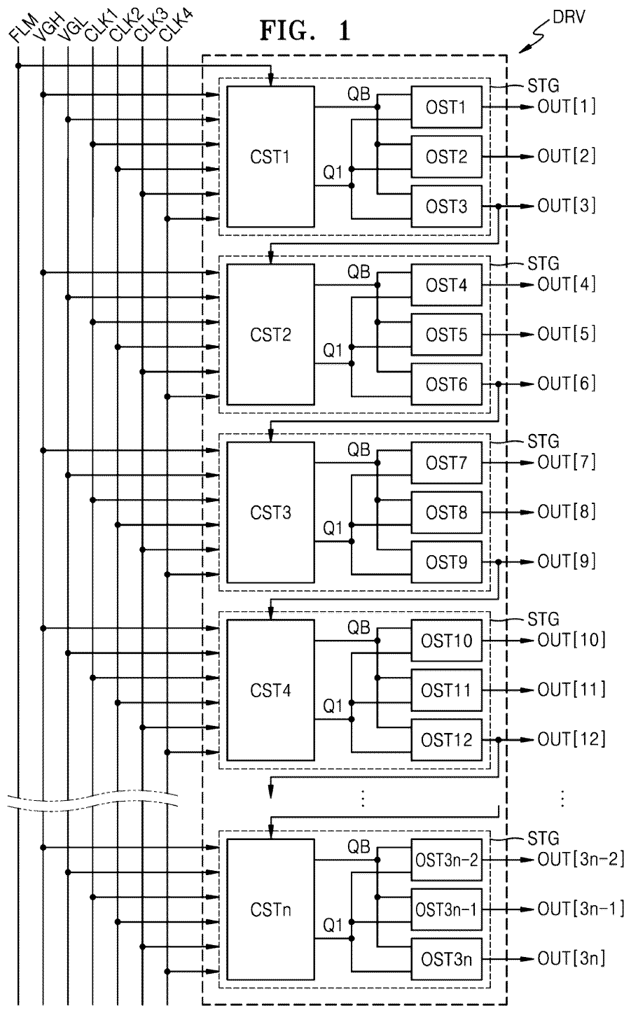

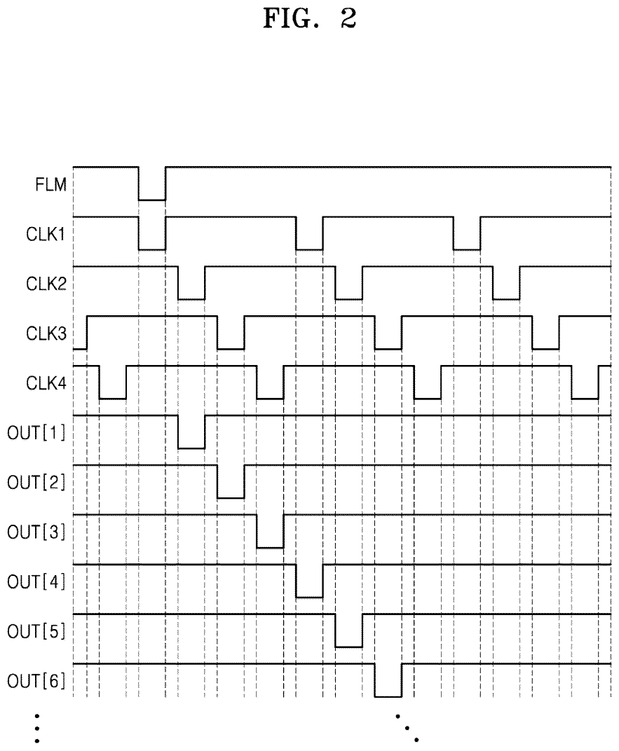

FIG. 1 is a view schematically illustrating a driving circuit according to an embodiment. FIG. 2 is a view schematically illustrating input/output signals of a driving circuit according to an embodiment.

Referring to FIG. 1, a driving circuit DRV may include a plurality of control stages CST1 through CSTn (where n is a positive integer more than 1) and a plurality of output stages OST1 through OST3n. The plurality of control stages CST1 through CSTn and the plurality of output stages OST1 through OST3n may be grouped into a plurality of stage groups STG. Each of the plurality of stage groups STG may include one control stage and at least two output stages, and at least two output stages may share one control stage. At least two output stages may be connected to one control stage through a first node Q1 and a third node QB that are common nodes. Each of the output stages OST1 through OST3n may be connected to a signal line, may generate an output signal, and may output the output signal via the connected signal line.

Each of the plurality of stage groups STG may receive a plurality of clock signals and a first voltage VGH and a second voltage VGL and may output a plurality of output signals.

Each of the plurality of control stages CST1 through CSTn may be connected to an input terminal to which a start signal is input, a first clock terminal, a second clock terminal, a first terminal to which the first voltage VGH is input, and a second terminal to which the second voltage VGL is input. Each of the plurality of control stages CST1 through CSTn may control a voltage of the first node Q1 and a voltage of the third node QB in response to the start signal and clock signals input to the first clock terminal and the second clock terminal.

Each of the output stages OST1 through OST3n may be connected to a first terminal and a third clock terminal and may be connected to the first node Q1 and the third node QB to output an output signal of a first level voltage or a third level voltage according to the voltages of the first node Q1 and the third node QB.

The number of clock signals input to the driving circuit DRV may be determined according to the number of stages or the number of output stages included in the stage group STG. In an embodiment, when the number of output stages included in one stage group STG is m−1 (where m is a positive integer equal to or more than 3), the plurality of clock signals may include m clock signals that are phase-shifted by a 1/m period. For example, when the stage group STG includes three stages, i.e., three output stages, the number of clock signals may be four. For example, when the stage group STG includes two stages, i.e., two output stages, the number of clock signals may be three.

A clock signal input to the second clock terminal may be one of the remaining clock signals except for a clock signal input to the first clock terminal among m clock signals. A clock signal input to the third clock terminal may be one of the remaining clock signals except for a clock signal input to the first clock terminal among m clock signals. Clock signals input to third clock terminals of m−1 output stages may be sequentially phase-shifted by a 1/m period. One of the clock signals input to the m−1 output stages and the clock signal input to the second clock terminal may be the same.

The number of the plurality of control stages CST1 through CSTn may be less than the number of the plurality of output stages OST1 through OST3n. The driving circuit DRV of FIG. 1 is an embodiment in which each stage group STG includes three output stages and the three output stages share one control stage.

The control stages CST1 through CSTn and the output stages OST1 through OST3n may start driving by receiving the start signal. The start signal may be an external signal FLM or a previous output signal. The external signal FLM as the start signal may be input to the first control stage CST1, and the previous output signal as a start signal may be input to each of subsequent control stages CST2 to CSTn. The previous output signal may be an output signal of an output stage which is the last output stage among output stages included in a preceding stage group STG.

The preceding stage group STG may be a stage group located at least one previously from the current stage group. In FIG. 1, the preceding stage group STG is a stage group located immediately before. For example, an external signal FLM as a start signal may be input to the first control stage CST1, and a ninth output signal OUT[9] output from the last output stage (e.g., a ninth output stage OST9) of the third stage group STG may be input as a start signal to the fourth control stage CST4.

In an embodiment, the first voltage VGH may be a positive voltage, and the second voltage VGL may be a negative voltage. In the present specification, a high-level voltage and a low-level voltage may mean a positive voltage and a negative voltage, respectively, however, embodiments are not limited thereto. For example, a relatively high voltage among the two voltages may be referred to as a high-level voltage (a first-level voltage), and a low voltage among the two voltages may be referred to as a low-level voltage (a second-level voltage).

The clock signal may include a first clock signal CLK1, a second clock signal CLK2, a third clock signal CLK3, and a fourth clock signal CLK4. As shown in FIG. 2, the first clock signal CLK1, the second clock signal CLK2, the third clock signal CLK3, and the fourth clock signal CLK4 may be square wave signals that repeat a high-level voltage and a low-level voltage. In an embodiment, the first clock signal CLK1, the second clock signal CLK2, the third clock signal CLK3, and the fourth clock signal CLK4 may be square wave signals that repeat the first voltage VGH and the second voltage VGL. The first clock signal CLK1, the second clock signal CLK2, the third clock signal CLK3, and the fourth clock signal CLK4 may be phase-shifted signals having the same waveform. For example, the second clock signal CLK2 has the same waveform as the first clock signal CLK1 and may be a phase-shifted (phase-delayed) clock signal from the first clock signal CLK1 at predetermined intervals.

The first clock signal CLK1, the second clock signal CLK2, the third clock signal CLK3, and the fourth clock signal CLK4 may swing a high-level voltage and a low-level voltage alternately in the same period. The first clock signal CLK1, the second clock signal CLK2, the third clock signal CLK3, and the fourth clock signal CLK4 may be sequentially shifted by a ¼ period. In an embodiment, in the first clock signal CLK1, the second clock signal CLK2, the third clock signal CLK3, and the fourth clock signal CLK4, a duration in which the high-level voltage is maintained for one period (hereinafter, referred to as a high-level duration) and a duration in which the low-level voltage is maintained for one period (hereinafter, referred to as a low-level duration) may be the same. In an embodiment, each of the first clock signal CLK1, the second clock signal CLK2, the third clock signal CLK3, and the fourth clock signal CLK4 may have a longer high-level duration than the low-level duration for one cycle.

The output signals OUT[1] to OUT[3n] output from the output stages OST1 to OST3n may be sequentially shifted by a predetermined period. For example, the output signals OUT[1] to OUT[3n] may be sequentially output while being shifted by a ¼ period of a clock signal. In an embodiment, the high-level voltage and the low-level voltage of the output signals OUT[1] to OUT[3n] may be the first voltage VGH and the second voltage VGL, respectively.

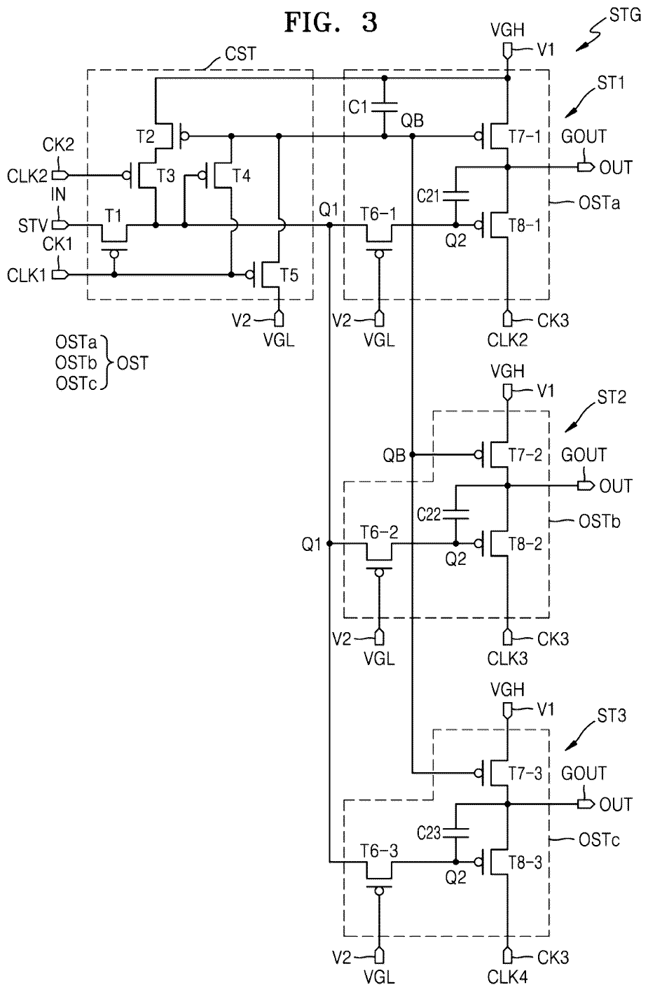

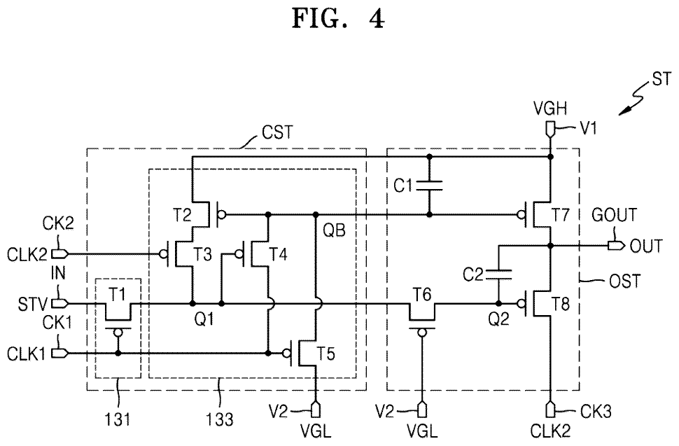

FIG. 3 are views schematically illustrating a stage group according to an embodiment. FIG. 4 is a view schematically illustrating a control stage and one output stage connected to the control stage of the stage group shown in FIG. 3.

Hereinafter, as shown in FIG. 4, connection between the control stage CST and one output stage OST in the stage group STG is referred to as a stage ST. For example, as shown in FIG. 3, the stage group STG may include three stages ST1, ST2, and ST3, and output stages OSTa, OSTb, and OSTc of each of three stages ST1, ST2, and ST3 may share one control stage CST through the first node Q1 and the third node QB.

Referring to FIGS. 3 and 4, each of the control stage CST and the output stage OST included in the stage ST may include at least one transistor. In an embodiment, at least one transistor may be a P-channel transistor. The P-channel transistor may be a silicon transistor. The silicon transistor may include a silicon semiconductor, and the silicon semiconductor may include amorphous silicon, polysilicon, or the like. For example, the silicon transistor may be a low temperature polycrystalline silicon (LTPS) thin-film transistor. A gate-on voltage of the P-channel transistor may be a low-level voltage and a gate-off voltage of the P-channel transistor may be a high-level voltage.

The control stage CST may include an input circuit 131 and a control circuit 133.

The input circuit 131 may be configured to transmit a signal input from the input terminal IN to the first node Q1. For example, the input circuit 131 may be configured to transmit a start signal STV (e.g., an external signal FLM or the previous output signal OUT′) in response to a clock signal. In an embodiment, the input circuit 131 may include a first transistor T1.

The first transistor T1 may be connected between the input terminal IN and the first node Q1. A gate of the first transistor T1 may be connected to a first clock terminal CK1. The first transistor T1 may be turned on when a clock signal input from the first clock terminal CK1 is at a low level, and may transmit the start signal STV input from the input terminal IN to the first node Q1. The clock signal input from the first clock terminal CK1 may be one of the first clock signal CLK1, the second clock signal CLK2, the third clock signal CLK3, and the fourth clock signal CLK4. FIG. 3 illustrates an embodiment in which the first clock signal CLK1 is input to the first clock terminal CK1.

The control circuit 133 may control the voltages of the second node Q2 and the third node QB according to the voltage of the first node Q1. The control circuit 133 may include second through fifth transistors T2 through T5.

The second transistor T2 may be connected between a first voltage input terminal V1 and the first node Q1. The second transistor T2 may be connected between the first voltage input terminal V1 and the third transistor T3. A gate of the second transistor T2 may be connected to the third node QB. The second transistor T2 may be turned on when the voltage of the third node QB is at a low level, and may transmit the first voltage VGH input from the first voltage input terminal V1 to the first node Q1 through the third transistor T3.

The third transistor T3 may be connected between the first voltage input terminal V1 and the first node Q1. The third transistor T3 may be connected between the second transistor T2 and the first node Q1. A gate of the third transistor T3 may be connected to the second clock terminal CK2. The third transistor T3 may be turned on when a clock signal input from the second clock terminal CK2 is at a low level, and may transmit the first voltage VGH transmitted by the second transistor T2 to the first node Q1.

The clock signal input to the second clock terminal CK2 may be one of the first clock signal CLK1, the second clock signal CLK2, the third clock signal CLK3, and the fourth clock signal CLK4. In an embodiment, the clock signal input from the second clock terminal CK2 may be one of the remaining clock signals except for the clock signal input to the first clock terminal CK1 among the first clock signal CLK1, the second clock signal CLK2, the third clock signal CLK3, and the fourth clock signal CLK4. For example, when the first clock signal CLK1 is input from the first clock terminal CK1, the clock signal input from the second clock terminal CK2 may be one of the second clock signal CLK2, the third clock signal CLK3, and the fourth clock signal CLK4. FIG. 3 illustrates an embodiment in which the second clock signal CLK2 is input from the second clock terminal CK2.

The fourth transistor T4 may be connected between the third node QB and the first clock terminal CK1. A gate of the fourth transistor T4 may be connected to the first node Q1. The fourth transistor T4 may be turned on when the voltage of the first node Q1 is at a low level, and may transmit the clock signal input from the first clock terminal CK1 to the third node QB.

The fifth transistor T5 may be connected between the third node QB and the second voltage input terminal V2. A gate of the fifth transistor T5 may be connected to the first clock terminal CK1. The fifth transistor T5 may be turned on when a clock signal input from the first clock terminal CK1 is at a low level, and may transmit the second voltage VGL input from the second voltage input terminal V2 to the third node QB.

Referring to FIG. 4, an output stage OST may be connected between the first voltage input terminal V1 and the third clock terminal CK3. The output stage OST may output an output signal OUT of the high-level voltage or the low-level voltage through an output terminal GOUT according to the voltages of the second node Q2 and the third node QB. The output stage OST may include a sixth transistor T6 (T6-1, T6-2 and T6-3), a seventh transistor T7 (T7-1, T7-2 and T7-3), and an eighth transistor T8 (T8-1, T8-2 and T8-3). The output stage OST (OSTa, OSTb and OSTc) may further include a first capacitor C1 and a second capacitor C2 (C21, C22 and C23).

Referring to FIG. 3, an output stage OSTa of the first stage ST1 may include a sixth transistor T6-1, a seventh transistor T7-1, an eighth transistor T8-1, a first capacitor C1, and a second capacitor C21. An output stage OSTb of the second stage ST2 may include a sixth transistor T6-2, a seventh transistor T7-2, an eighth transistor T8-2, a first capacitor C1, and a second capacitor C22. An output stage OSTc of the third stage ST3 may include a sixth transistor T6-3, a seventh transistor T7-3, an eighth transistor T8-3, a first capacitor C1, and a second capacitor C23.

Although the reference numeral of the corresponding circuit elements of each of the output stages are differently assigned for convenience of understanding in FIG. 3, it will be described that each output stage OST includes a sixth transistor T6, a seventh transistor T7, an eighth transistor T8, a first capacitor C1, and a second capacitor C2 for convenience of explanation.

The sixth transistor T6 may be connected between the first node Q1 and the second node Q2. A gate of the sixth transistor T6 may be connected to the second voltage input terminal V2. The sixth transistor T6 may be turned on by the second voltage VGL input from the second voltage input terminal V2 and may transmit a signal from the first node Q1 to the second node Q2.

The seventh transistor T7 may be connected between the first voltage input terminal V1 and the output terminal GOUT. A gate of the seventh transistor T7 may be connected to the third node QB. The seventh transistor T7 may be a pull-up transistor that transmits a high-level voltage to the output terminal GOUT. The seventh transistor T7 may be turned on when the voltage of the third node QB is at a low level, and may transmits the first voltage VGH that is a high-level voltage input from the first voltage input terminal V1 to the output terminal GOUT.

The eighth transistor T8 may be connected between the output terminal GOUT and the third clock terminal CK3. A gate of the eighth transistor T8 may be connected to the second node Q2. The eighth transistor T8 may be a pull-down transistor that transmits a low-level voltage to the output terminal GOUT. The eighth transistor T8 may be turned on when the voltage of the second node Q2 is at a low level, and may transmit the clock signal input from the third clock terminal CK3 to the output terminal GOUT. The clock signal input from the third clock terminal CK3 may be one of the first clock signal CLK1, the second clock signal CLK2, the third clock signal CLK3, and the fourth clock signal CLK4.

In an embodiment, the clock signal input from the third clock terminal CK3 of each of the output stages OSTa, OSTb, and OSTc in the stage group STG may be one of the remaining clock signals except for the clock signal (e.g., the first clock signal CLK1) input to the first clock terminal CK1 among the first clock signal CLK1, the second clock signal CLK2, the third clock signal CLK3, and the fourth clock signal CLK4. Clock signals input from the third clock terminals CK3 of the output stages OSTa, OSTb, and OSTc may not overlap each other. The clock signals input to the output stages OSTa, OSTb, and OSTc may be sequentially phase-shifted to correspond to the connection order of the output stages OSTa, OSTb, and OSTc of the stage group STG. For example, when the first clock signal CLK1 is input to the first clock terminal CK1 of the control stage CST in the stage group STG, the second clock signal CLK2 may be input to the third clock terminal CK3 of the first output stage OSTa, the third clock signal CLK3 may be input to the third clock terminal CK3 of the second output stage OSTb, and the fourth clock signal CLK4 may be input to the third clock terminal CK3 of the third output stage OSTc.

The first capacitor C1 may be connected between the first voltage input terminal V1 and the third node QB. The first capacitor C1 may maintain the voltage of the third node QB stably.

The second capacitor C2 may be connected between the output terminal GOUT and the second node Q2. When the second node Q2 is in a floating state, the second capacitor C2 may couple the voltage of the second node Q2 according to the voltage change of the output terminal GOUT. When the voltage of the output terminal GOUT decreases from a high level to a low level, the voltage level of the low level voltage of the second node Q2 may decrease by the coupling of the second capacitor C2.

Hereinafter, the operation of the stage and the stage group shown in FIGS. 3 and 4 will be described.

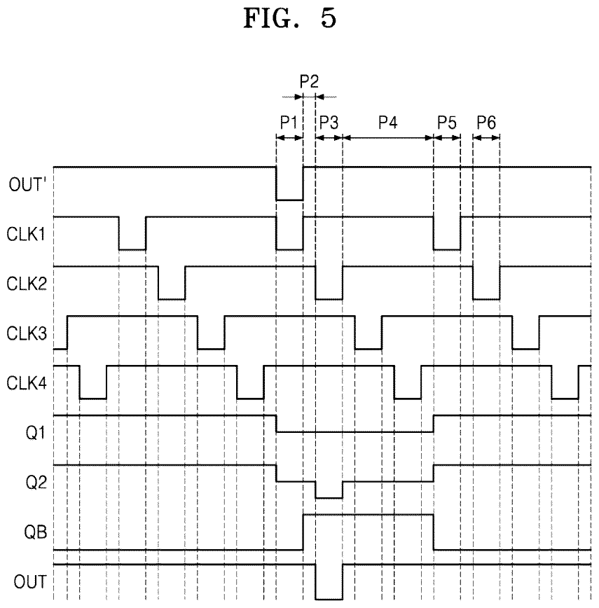

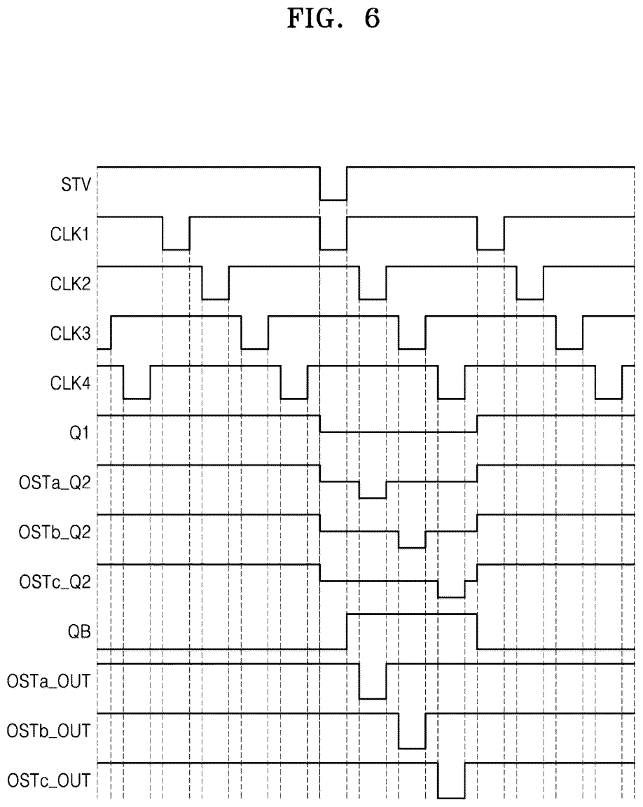

FIG. 5 is a timing diagram for describing driving of the stage of FIG. 4. FIG. 6 is a timing diagram for describing driving of the stage group of FIG. 3.

Hereinafter, the operation of the stage ST shown in FIG. 4 will be described with reference to FIG. 5. FIG. 5 is a timing diagram of an example in which the stage ST of FIG. 4 is the first stage ST1 of the stage group STG of FIG. 3. A start signal STV may be the previous output signal OUT′, and the previous output signal OUT′ may be an output signal output from the last output stage OST of the previous stage group STG (e.g., the third output stage OSTc of the previous stage group STG).

The timing diagram of FIG. 6 illustrates voltages of the first node Q1 and the third node QB, a voltage of a second node OSTa_Q2 of a first output stage OSTa, a voltage of a second node OSTb_Q2 of a second output stage OSTb, and a voltage of a second node OSTc_Q2 of a third output stage OSTc together. The first node Q1 and the third node QB are common nodes which are connected commonly to the first output stage OSTa, the second output stage OSTb, and the third output stage OSTc, respectively.

Hereinafter, an example in which the first clock signal CLK1 is input to the first clock terminal CK1 of the control stage CST in the stage group STG, the second clock signal CLK2 is input to the third clock terminal CK3 of the first output stage OSTa, the third clock signal CLK3 is input to the third clock terminal CK3 of the second output stage OSTb, and the fourth clock signal CLK4 is input to the third clock terminal CK3 of the third output stage OSTc will be described.

In a first section P1, a low-level previous output signal OUT′ may be input to the input terminal IN, a low-level first clock signal CLK1 may be input to the first clock terminal CK1, a high-level second clock signal CLK2 may be input to the second clock terminal CK2, and a high-level second clock signal CLK2 may be input to the third clock terminal CK3.

The first transistor T1 may be turned on by the low-level first clock signal CLK1, and the low-level previous output signal OUT′ may be transmitted to the first node Q1 by the turned-on first transistor T1, and the voltage of the first node Q1 may be a low-level voltage. The sixth transistor T6 may be in a turned-on state by the low-level second voltage VGL, the first node Q1 and the second node Q2 may be electrically connected by the turned-on sixth transistor T6, a signal (e.g., a previous output signal OUT′) of the first node Q1 may be transmitted to the second node Q2, and a voltage of the second node Q2 may be a low-level voltage.

The fifth transistor T5 may be turned on by the low-level first clock signal CLK1, and the second voltage VGL may be transmitted to the third node QB by the turned-on fifth transistor T5. The fourth transistor T4 having a gate connected to the first node Q1 may be turned on, and the low-level first clock signal CLK1 may be transmitted to the third node QB by the turned-on fourth transistor T4. Thus, the voltage of the third node QB may maintain the low-level voltage of the previous section.

The second transistor T2 having a gate connected to the third node QB may be turned on, and the third transistor T3 may be turned off by the high-level second clock signal CLK2.

The eighth transistor T8 having a gate connected to the second node Q2 may be turned on, and the high-level second clock signal CLK2 may be transmitted to the output terminal GOUT by the turned-on eighth transistor T8. The seventh transistor T7 having a gate connected to the third node QB may be turned on, and the high-level first voltage VGH may be transmitted to the output terminal GOUT by the turned-on seventh transistor T7. Thus, the high-level output signal OUT may be output from the output terminal GOUT. Meanwhile, when the voltage of the first node Q1 reaches the second voltage VGL, the sixth transistor T6 may be turned off.

In a second section P2, a high-level previous output signal OUT′ may be input from the input terminal IN, a high-level first clock signal CLK1 may be input from the first clock terminal CK1, a high-level second clock signal CLK2 may be input from the second clock terminal CK2, and a high-level second clock signal CLK2 may be input from the third clock terminal CK3.

The first transistor T1 and the fifth transistor T5 may be turned off by the high-level first clock signal CLK1, and the fourth transistor T4 may be in a turned-on state by the voltage of the first node Q1. The voltages of the first node Q1 and the second node Q2 may maintain the low-level voltages of a previous period (e.g., a first section P1).

The high-level first clock signal CLK1 may be transmitted to the third node QB by the fourth transistor T4 having a gate connected to the first node Q1, and the voltage of the third node QB may be a high-level voltage. The seventh transistor T7 having a gate connected to the third node QB may be turned off.

The high-level second clock signal CLK2 may be transmitted to the output terminal GOUT through the eighth transistor T8 having a gate connected to the second node Q2 which has a low level voltage. Thus, the high-level output signal OUT may be output from the output terminal GOUT.

In a third section P3, a high-level previous output signal OUT′ may be input from the input terminal IN, a high-level first clock signal CLK1 may be input from the first clock terminal CK1, a low-level second clock signal CLK2 may be input from the second clock terminal CK2, and a low-level second clock signal CLK2 may be input from the third clock terminal CK3.

The first transistor T1 may be maintained in a turned-off state by the high-level first clock signal CLK1, the high-level first clock signal CLK1 may be transmitted to the third node QB by the fourth transistor T4 having a gate connected to the first node Q1 of the low-level voltage, and the voltage of the third node QB may be a high-level voltage. The seventh transistor T7 having a gate coupled to the third node QB may be turned off.

The low-level second clock signal CLK2 may be transmitted to the output terminal GOUT by the eighth transistor T8 having a gate connected to the second node Q2 at a low-level voltage. Thus, the low-level output signal OUT may be output from the output terminal GOUT. Because the sixth transistor T6 may be in a turned off state and the voltage of the output terminal GOUT decreases from the high level to the low level, the voltage of the second node Q2 may be further decreased by the coupling of the second capacitor C2, so that the voltage level of the second node Q2 may further decrease.

In a fourth section P4, a high-level previous output signal OUT′ may be input from the input terminal IN, a high-level first clock signal CLK1 may be from to the first clock terminal CK1, a high-level second clock signal CLK2 may be input from the second clock terminal CK2, and a high-level second clock signal CLK2 may be input from the third clock terminal CK3.

The first transistor T1 may be maintained to be turned off by the high-level first clock signal CLK1, and the voltage of the first node Q1 may be maintained at the low-level voltage. The high-level first clock signal CLK1 may be transmitted to the third node QB by the fourth transistor T4 having a gate connected to the first node Q1, and the voltage of the third node QB may be a high-level voltage. The seventh transistor T7 having a gate coupled to the third node QB may be turned off.

The high-level second clock signal CLK2 may be transmitted to the output terminal GOUT by the eighth transistor T8 having a gate connected to the second node Q2. Thus, the high-level output signal OUT may be output from the output terminal GOUT. Because the sixth transistor T6 may be in a turned off state and the voltage of the output terminal GOUT increases from the low level to the high level, the voltage of the second node Q2 may be increased by the coupling of the second capacitor C2, so that the voltage level of the second node Q2 may increase.

In a fifth section P5, a high-level previous output signal OUT′ may be input from the input terminal IN, a low-level first clock signal CLK1 may be input from the first clock terminal CK1, a high-level second clock signal CLK2 may be input from the second clock terminal CK2, and a high-level second clock signal CLK2 may be input from the third clock terminal CK3.

The first transistor T1 may be turned on by the low-level first clock signal CLK1, and the high-level previous output signal OUT′ may be transmitted to the first node Q1 by the turned-on first transistor T1, and the voltage of the first node Q1 may be a high-level voltage. The sixth transistor T6 may be turned on as the voltage of the first node Q1 is shifted to the high-level voltage, and a signal of the first node Q1 (e.g., the previous output signal OUT′) may be transmitted to the second node Q2, and the voltage of the second node Q2 may be a high-level voltage. The fourth transistor T4 having a gate connected to the first node Q1 may be turned off, and the eighth transistor T8 having a gate connected to the second node Q2 may be turned off.

The fifth transistor T5 may be turned on by the low-level first clock signal CLK1, and the second voltage VGL may be transmitted to the third node QB by the turned-on fifth transistor T5. The voltage of the third node QB may be a low-level voltage. The second transistor T2 and the seventh transistor T7 each of which a gate connected to the third node QB may be turned on, and the third transistor T3 may be turned off by the high-level second clock signal CLK2. The high-level first voltage VGH may be transmitted to the output terminal GOUT by the turned-on seventh transistor T7. Thus, the high-level output signal OUT may be output from the output terminal GOUT.

In a sixth section P6, a high-level previous output signal OUT′ may be input from the input terminal IN, a high-level first clock signal CLK1 may be input from the first clock terminal CK1, a low-level second clock signal CLK2 may be input from the second clock terminal CK2, and a low-level second clock signal CLK2 may be input from the third clock terminal CK3.

The first transistor T1 may be turned off by the high-level first clock signal CLK1, and the sixth transistor T6 may be in a turned-off state. Voltages of the first node Q1 and the second node Q2 may be maintained as high-level voltages. The fourth transistor T4 having a gate connected to the first node Q1 may be turned off, and the eighth transistor T8 having a gate connected to the second node Q2 may be turned off.

The fifth transistor T5 may be turned off by the high-level first clock signal CLK1, and the voltage of the third node QB may be maintained at the low-level voltage. The second transistor T2 and the seventh transistor T7 each of which a gate connected to the third node QB may be turned on. The third transistor T3 may be turned on by the low-level second clock signal CLK2, and the high-level first voltage VGH may be transferred to the first node Q1 by the turned-on second transistor T2 and the third transistor T3. Thus, while the high-level output signal OUT is output from the output terminal GOUT, the voltages of the first node Q1 and the second node Q2 may be stably maintained.

Referring to FIG. 6, a first output stage OSTa among the output stages OSTa, OSTb, and OSTc in the stage group STG may output the output signal OSTa_OUT synchronized with the second clock signal CLK2 input from the third clock terminal CK3. The second output stage OSTb may output the output signal OSTb_OUT synchronized with the third clock signal CLK3 input from the third clock terminal CK3. The third output stage OSTc may output the output signal OSTc_OUT synchronized with the fourth clock signal CLK4 input from the third clock terminal CK3. The output stages OSTa, OSTb, and OSTc in the stage group STG may sequentially output the shifted output signals OSTa_OUT, OSTb_OUT, and OSTc_OUT.

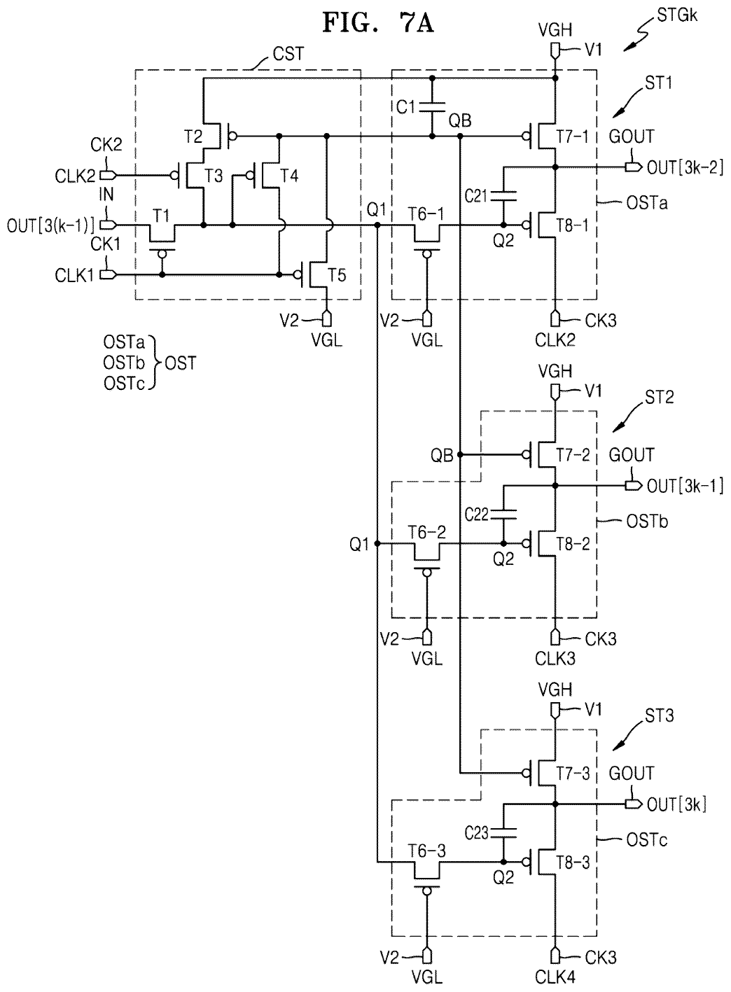

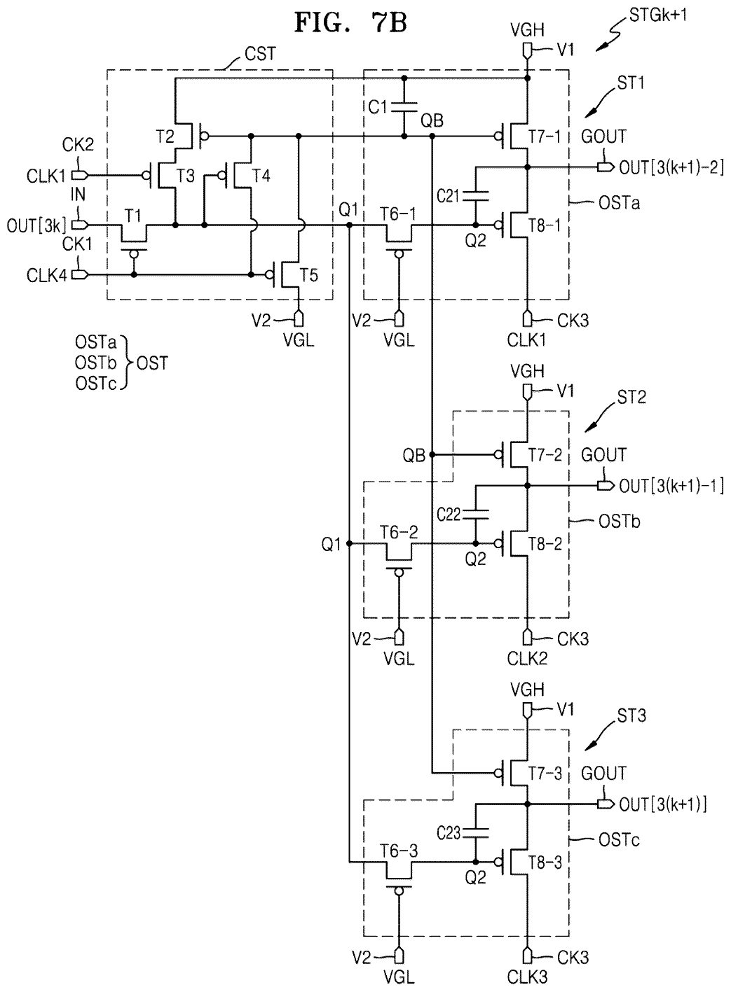

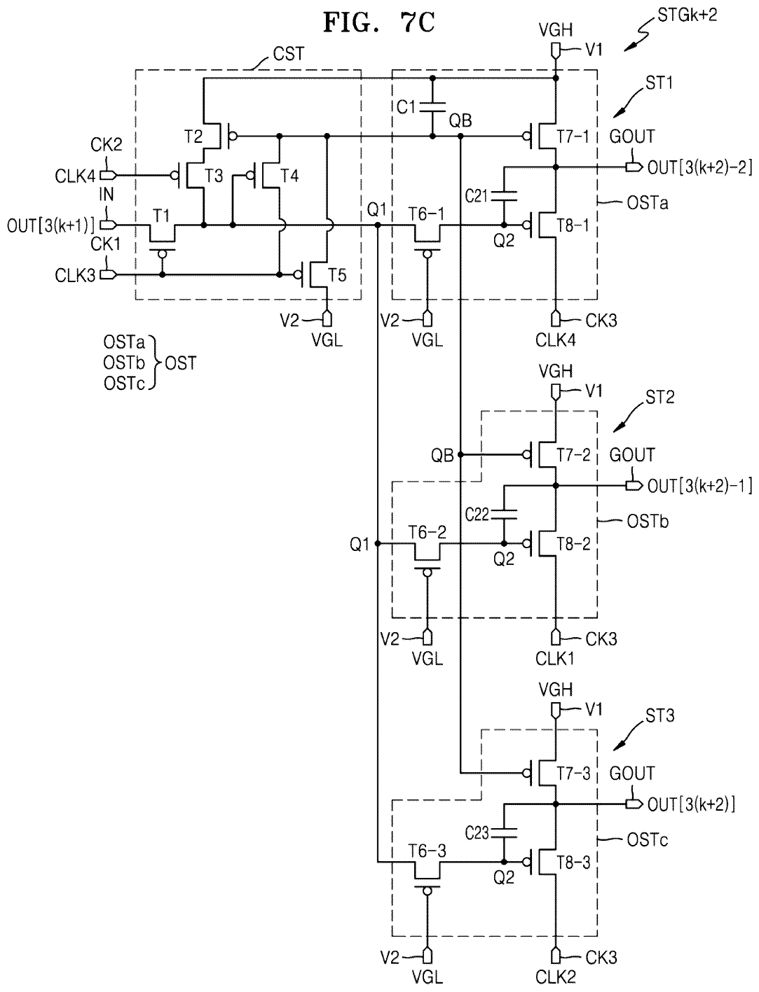

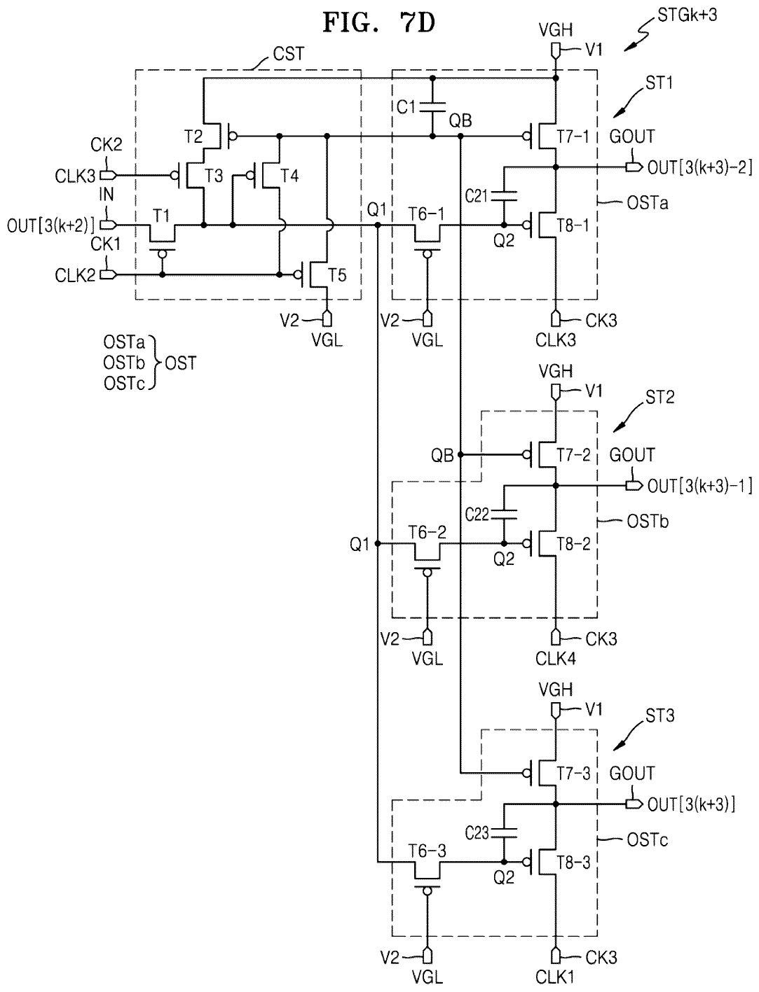

FIGS. 7A through 7D are views illustrating stage groups according to an embodiment.

FIGS. 7A through 7D represent four k-th stage groups STGk, k+1th stage groups STGk+1, k+2th stage groups STGk+2, and k+3th stage groups STGk+3, which are arranged sequentially. The driving circuit DRV of FIG. 1 may have a structure in which the four stage groups of FIGS. 7A through 7D are repeatedly arranged.

Referring to FIG. 7A, a previous output signal OUT[3(k−1)] may be input from the input terminal IN of the k-th stage group STGk, the first clock signal CLK1 may be input from the first clock terminal CK1, and the second clock signal CLK2 may be input from the second clock terminal CK2. The second clock signal CLK2 may be input from the third clock terminal CK3 of the first output stage OSTa among the three output stages OSTa, OSTb, and OSTc, and the output signal OUT[3k−2] may be output from the output terminal GOUT of the first output stage OSTa. The third clock signal CLK3 may be input from the third clock terminal CK3 of the second output stage OSTb among the three output stages OSTa, OSTb, and OSTc, and an output signal OUT[3k−1] may be output from the output terminal GOUT of the second output stage OSTb. The fourth clock signal CLK4 may be input from the third clock terminal CK3 of the third output stage OSTc among the three output stages OSTa, OSTb, and OSTc, and an output signal OUT[3k] may be output from the output terminal GOUT of the third output stage OSTc.

Referring to FIG. 7B, a previous output signal OUT[3k] may be input from the input terminal IN of the k-th stage group STGk+1, the fourth clock signal CLK4 may be input from the first clock terminal CK1, and the first clock signal CLK1 may be input from the second clock terminal CK2. The first clock signal CLK1 may be input from the third clock terminal CK3 of the first output stage OSTa among the three output stages OSTa, OSTb, and OSTc, and the output signal OUT[3(k+1)−2] may be output from the output terminal GOUT of the first output stage OSTa. The second clock signal CLK2 may be input from the third clock terminal CK3 of the second output stage OSTb among the three output stages OSTa, OSTb, and OSTc, and the output signal OUT[3(k+1)−1] may be output from the output terminal GOUT of the second output stage OSTb. The third clock signal CLK3 may be input from the third clock terminal CK3 of the third output stage OSTc among the three output stages OSTa, OSTb, and OSTc, and an output signal OUT[3(k+1)] may be output from the output terminal GOUT of the third output stage OSTc.

Referring to FIG. 7C, a previous output signal OUT[3(k+1)] may be input from the input terminal IN of the k+2th stage group STGk+2, the third clock signal CLK3 may be input from the first clock terminal CK1, and the fourth clock signal CLK4 may be input from the second clock terminal CK2. The fourth clock signal CLK4 may be input from the third clock terminal CK3 of the first output stage OSTa among the three output stages OSTa, OSTb, and OSTc, and the output signal OUT[3(k+2)−2] may be output from the output terminal GOUT of the first output stage OSTa. The first clock signal CLK1 may be input from the third clock terminal CK3 of the second output stage OSTb among the three output stages OSTa, OSTb, and OSTc, and the output signal OUT[3(k+2)−1] may be output from the output terminal GOUT of the second output stage OSTb. The second clock signal CLK2 may be input from the third clock terminal CK3 of the third output stage OSTc among the three output stages OSTa, OSTb, and OSTc, and an output signal OUT[3(k+2)] may be output from the output terminal GOUT of the third output stage OSTc.

Referring to FIG. 7D, a previous output signal OUT[3(k+2)] may be input from the input terminal IN of the k+3th stage group STGk+3, the second clock signal CLK2 may be input from the first clock terminal CK1, and the third clock signal CLK3 may be input from the second clock terminal CK2. The third clock signal CLK3 may be input from the third clock terminal CK3 of the first output stage OSTa among the three output stages OSTa, OSTb, and OSTc, and the output signal OUT[3(k+3)−2] may be output from the output terminal GOUT of the first output stage OSTa. The fourth clock signal CLK4 may be input from the third clock terminal CK3 of the second output stage OSTb among the three output stages OSTa, OSTb, and OSTc, and the output signal OUT[3(k+3)−1] may be output from the output terminal GOUT of the second output stage OSTb. The first clock signal CLK1 may be input from the third clock terminal CK3 of the third output stage OSTc among the three output stages OSTa, OSTb, and OSTc, and an output signal OUT[3(k+3)] may be output from the output terminal GOUT of the third output stage OSTc.

As shown in FIGS. 7A through 7D, clock signals may be sequentially input to each of the first clock terminals CK1 of the four stage groups STGk, STGk+1, STGk+2, and STGk+3 in the order of the first clock signal CLK1, the fourth clock signal CLK4, the third clock signal CLK3, and the second clock signal CLK2.

Clock signals may be sequentially input to each of the second clock terminals CK2 of the four stage groups STGk, STGk+1, STGk+2, and STGk+3 in the order of the second clock signal CLK2, the first clock signal CLK1, the fourth clock signal CLK4, and the third clock signal CLK3.

Clock signals may be sequentially input from each of the third clock terminals CK3 of the output stages OSTa, OSTb, and OSTc of the first stage group STGk among the four stage groups STGk, STGk+1, STGk+2, and STGk+3 in the order of the second clock signal CLK2, the third clock signal CLK3, and the fourth clock signal CLK4.

Clock signals may be sequentially input to each of the third clock terminals CK3 of the output stages OSTa, OSTb, and OSTc of the second stage group STGk+1 among the four stage groups STGk, STGk+1, STGk+2, and STGk+3 in the order of the first clock signal CLK1, the second clock signal CLK2, and the third clock signal CLK3.

Clock signals may be sequentially input to each of the third clock terminals CK3 of the output stages OSTa, OSTb, and OSTc of the third stage group STGk+2 among the four stage groups STGk, STGk+1, STGk+2, and STGk+3 in the order of the fourth clock signal CLK4, the first clock signal CLK1, and the second clock signal CLK2.

Clock signals may be sequentially input to each of the third clock terminals CK3 of the output stages OSTa, OSTb, and OSTc of the fourth stage group STGk+3 among the four stage groups STGk, STGk+1, STGk+2, and STGk+3 in the order of the third clock signal CLK3, the fourth clock signal CLK4, and the first clock signal CLK1.

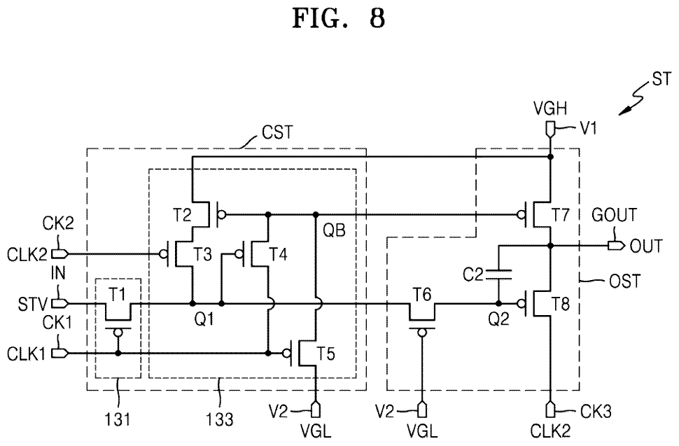

FIG. 8 is a view schematically illustrating a stage according to an embodiment.

A stage ST shown in FIG. 8 is an embodiment in which the first capacitor C1 is omitted from the stage ST shown in FIG. 4.

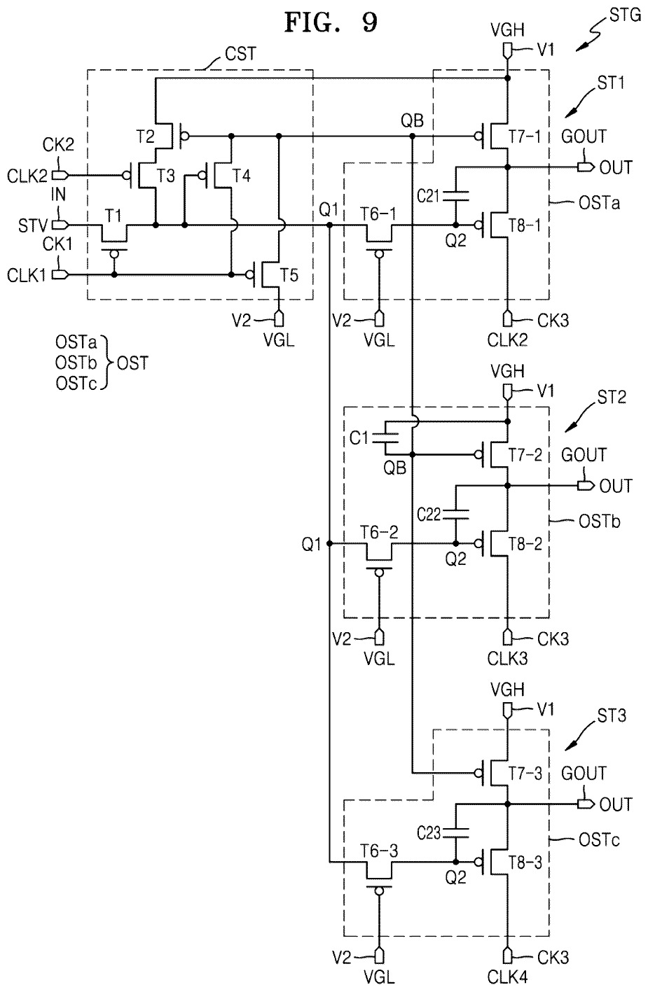

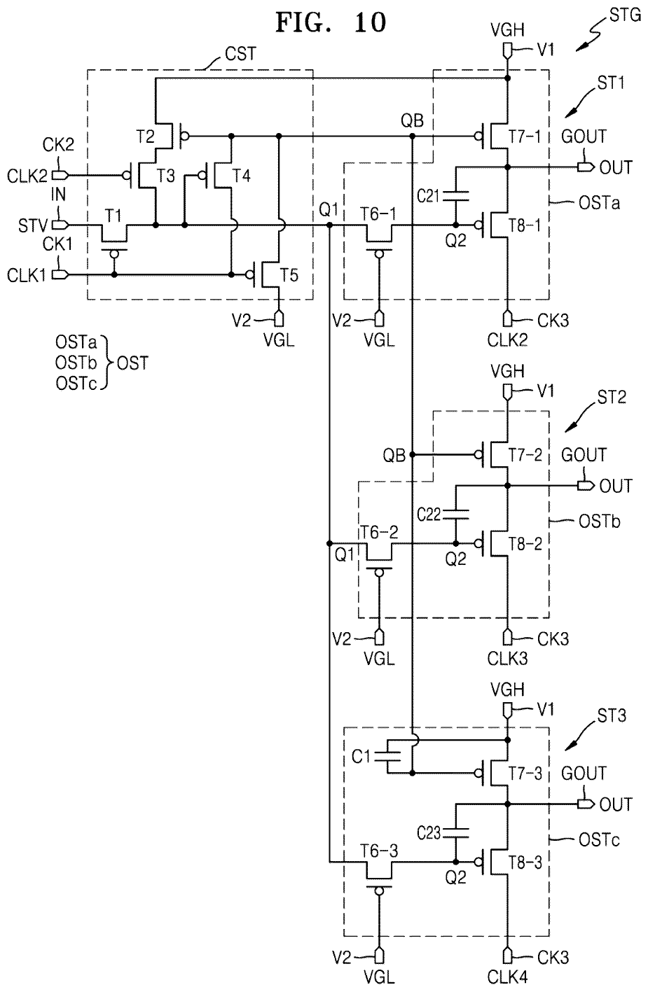

FIGS. 9 and 10 are views schematically illustrating a stage group according to an embodiment.

The stage group STG shown in FIG. 3 is an example in which the first capacitor C1 is disposed at the first output stage OST. Embodiments of the disclosure are not limited thereto. In an embodiment, the first capacitor C1 may be disposed at least one of a plurality of output stages OST that share the first node Q1 and the third node QB in the stage group STG. For example, as illustrated in FIG. 9, the first capacitor C1 may be disposed at the second output stage OSTb, or as illustrated in FIG. 10, the first capacitor C1 may be disposed at the third output stage OSTc. In an embodiment, the first capacitor C1 may be distributed and disposed at each of the first output stage OSTa, the second output stage OSTb, and the third output stage OSTc.

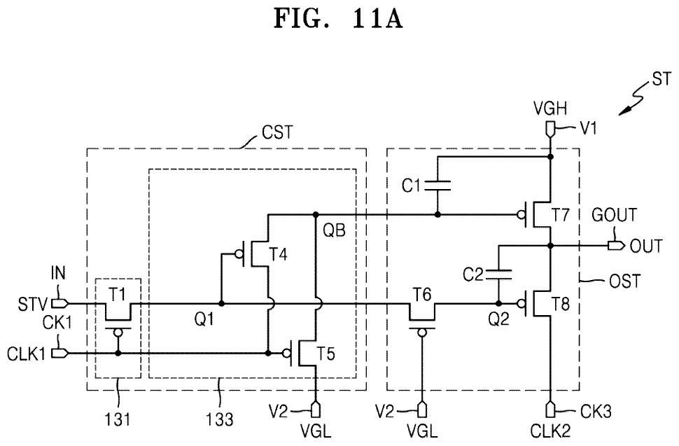

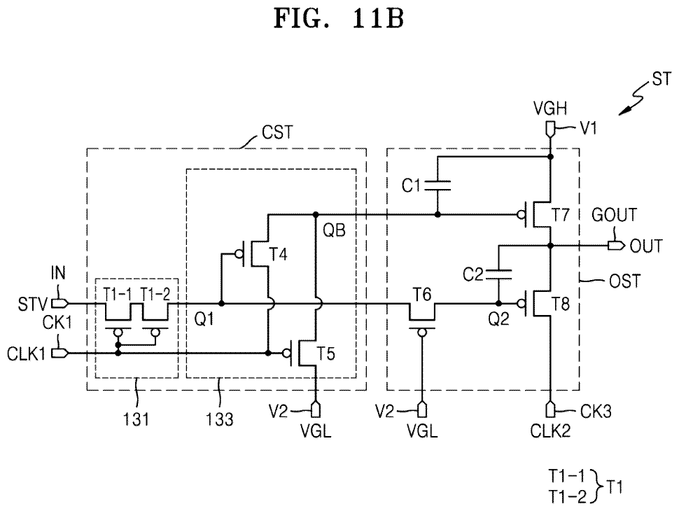

FIGS. 11A and 11B are views schematically illustrating a stage according to an embodiment.

A stage ST shown in FIG. 11A is an embodiment in which the second transistor T2 and the third transistor T3 are omitted from the stage ST shown in FIG. 4. A stage ST shown in FIG. 11B is an embodiment including a plurality of sub-transistors in which the first transistor T1 is connected in series on the stage ST shown in FIG. 11A. The first transistor T1 may include a first sub-transistor T1-1 and a second sub-transistor T1-2. The first sub-transistor T1-1 and the second sub-transistor T1-2 may be connected in series between the input terminal IN and the first node Q1. Gates of the first sub-transistor T1-1 and the second sub-transistor T1-2 may be connected to the first clock terminal CK1.

As shown in FIG. 8 (similar to FIG. 8), the first capacitor C1 may be omitted from the stages ST shown in FIGS. 11A and 11B.

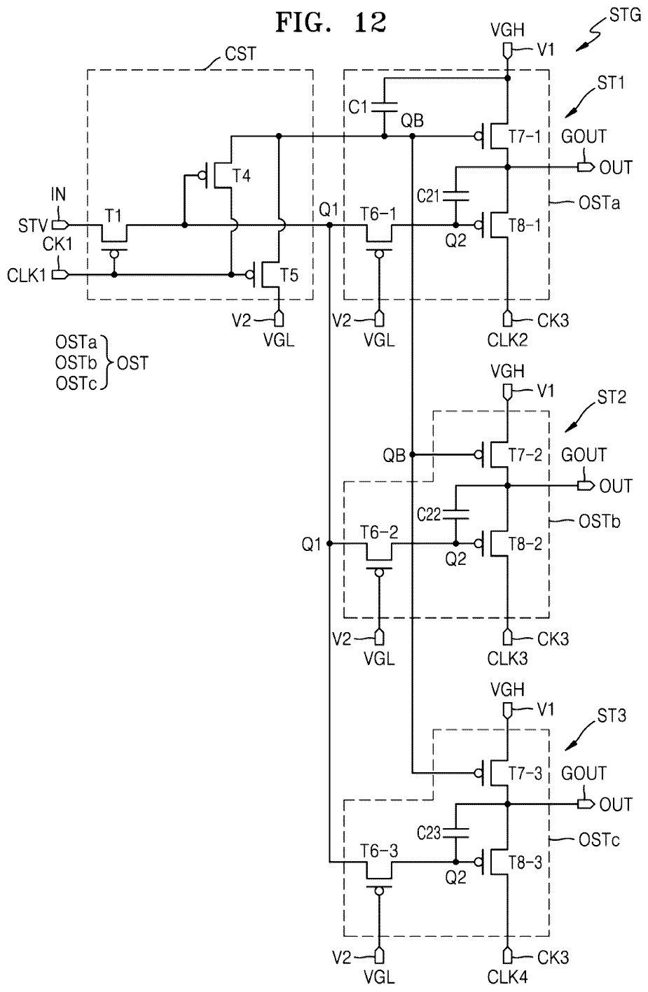

Driving of the stages ST shown in FIGS. 11A and 11B is the same as described with reference to FIG. 5 except for driving of the second transistor T2 and the third transistor T3. FIG. 12 is a view schematically illustrating a stage group according to an embodiment. The stage group STG illustrated in FIG. 12 includes three stages ST1, ST2, and ST3, and each of the three stages ST1, ST2, and ST3 may be the stage ST illustrated in FIG. 11A. Each of the output stages OSTa, OSTb, and OSTc of the three stages ST1, ST2, and ST3 may share the control stage CST shown in FIG. 11A through the first node Q1 and the third node QB.

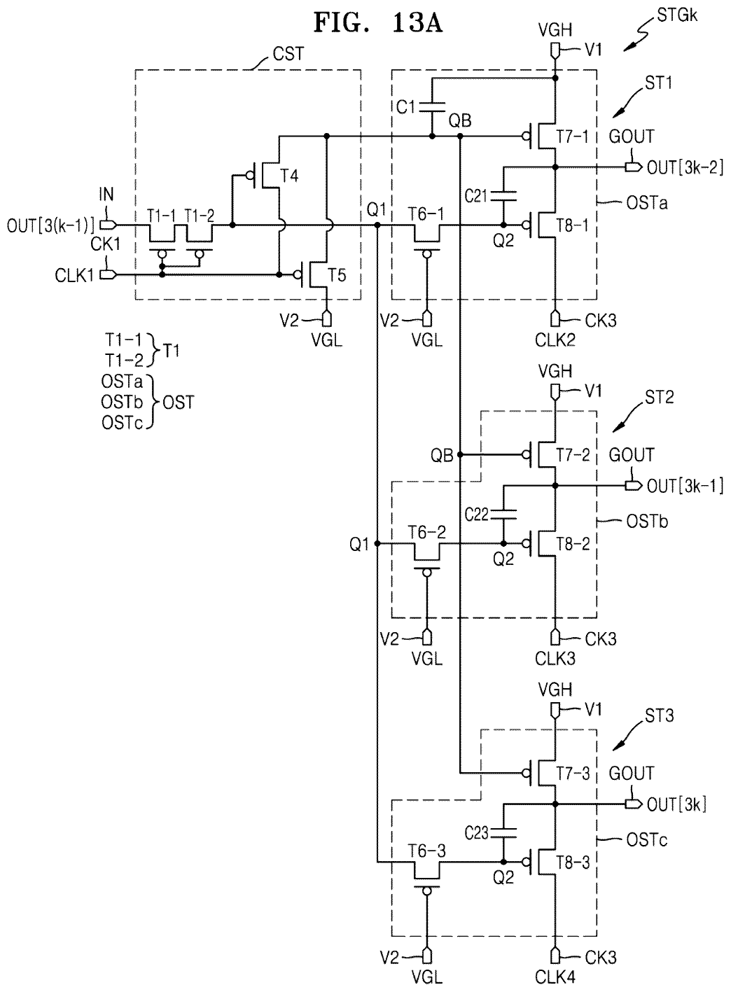

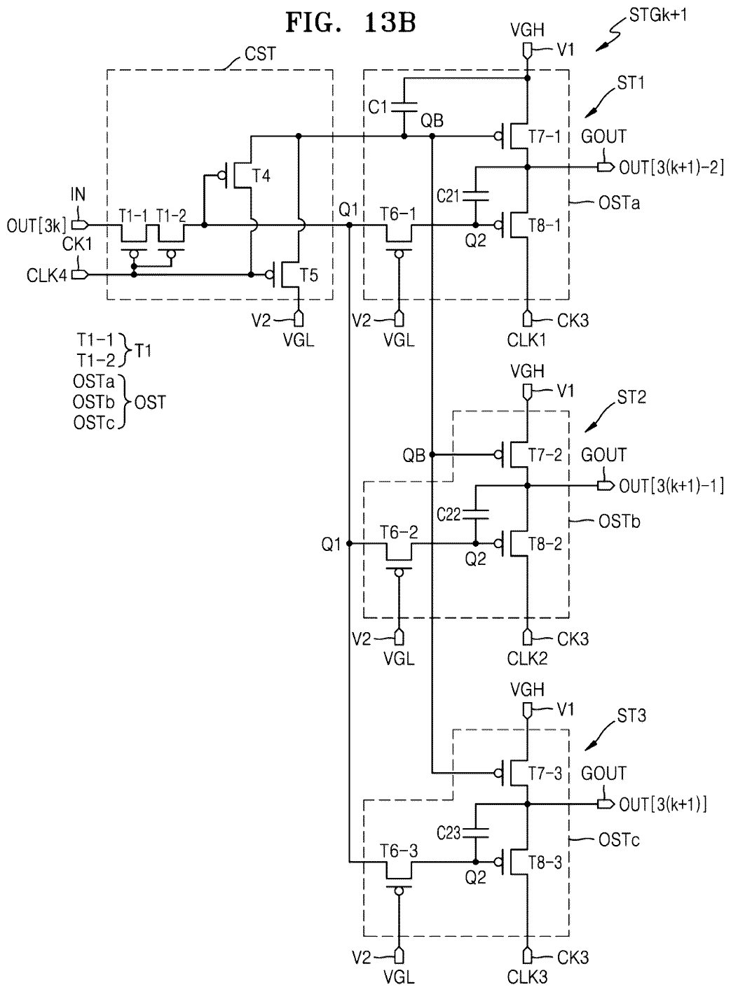

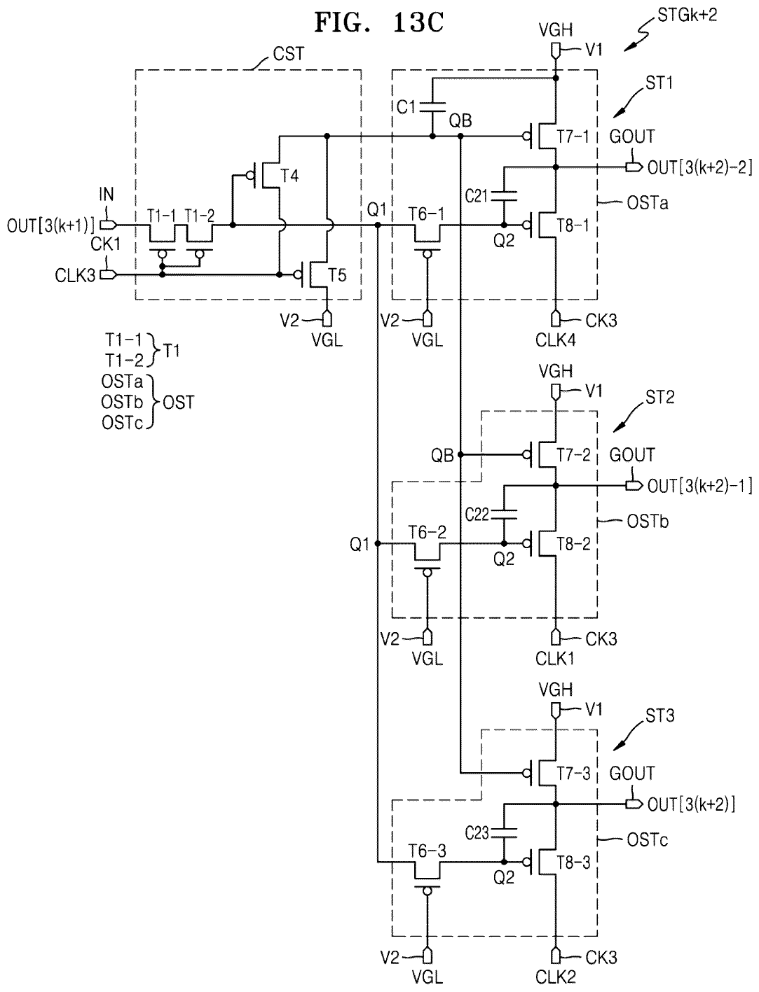

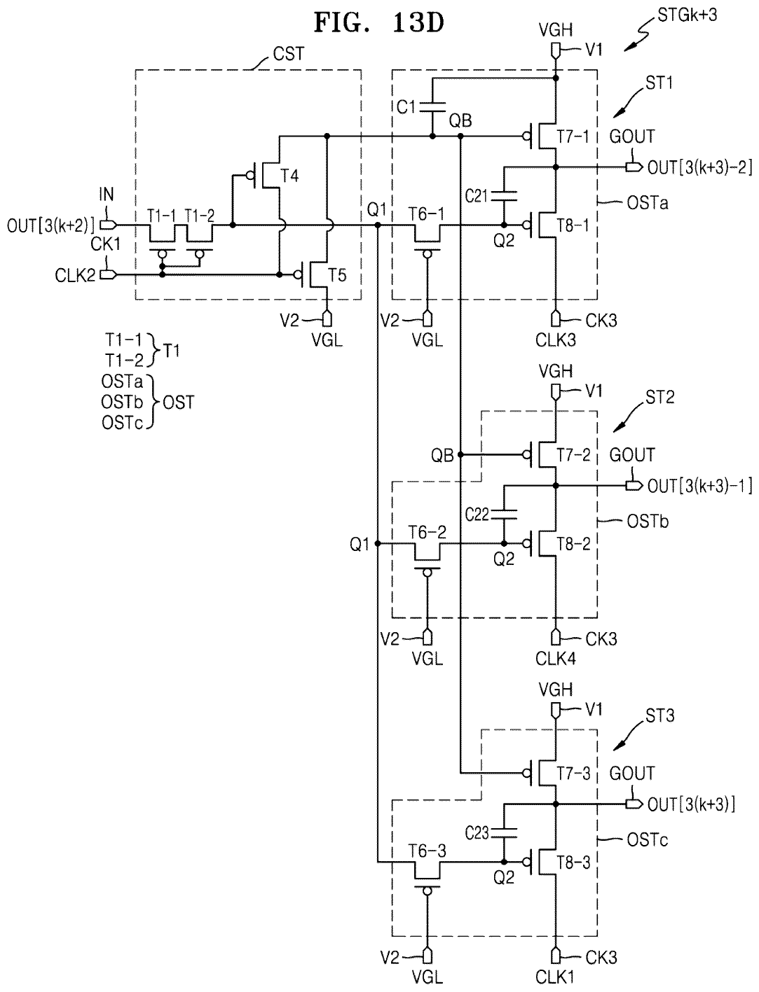

FIGS. 13A through 13D are views illustrating stage groups according to an embodiment. Each of the stages ST1, ST2, and ST3 of FIGS. 13A to 13D may be the stage ST illustrated in FIG. 11B.

Driving of the stages ST shown in FIGS. 12 and 13A through 13D is the same as described with reference to FIG. 6 except for the driving of the second transistor T2 and the third transistor T3.

The stage group STG shown in FIGS. 12 and 13A through 13D is an example in which the first capacitor C1 is disposed at the first output stage OSTa. In an embodiment, as illustrated in FIG. 9, the first capacitor C1 may be disposed at the second output stage OSTb, or as illustrated in FIG. 10, the first capacitor C1 may be disposed at the third output stage OSTc. In an embodiment, the first capacitor C1 may be distributed and disposed at each of the first output stage OSTa, the second output stage OSTb, and the third output stage OSTc.

In the above-described embodiment, the stage includes at least one P-channel transistor, however, embodiments of disclosure are not limited thereto. For example, the stage may include at least one N-channel transistor.

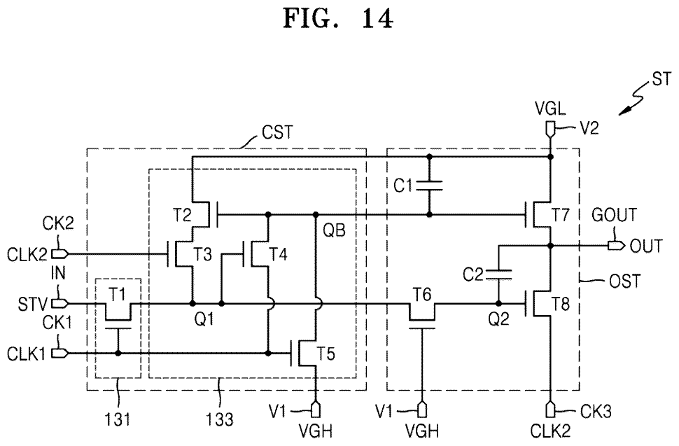

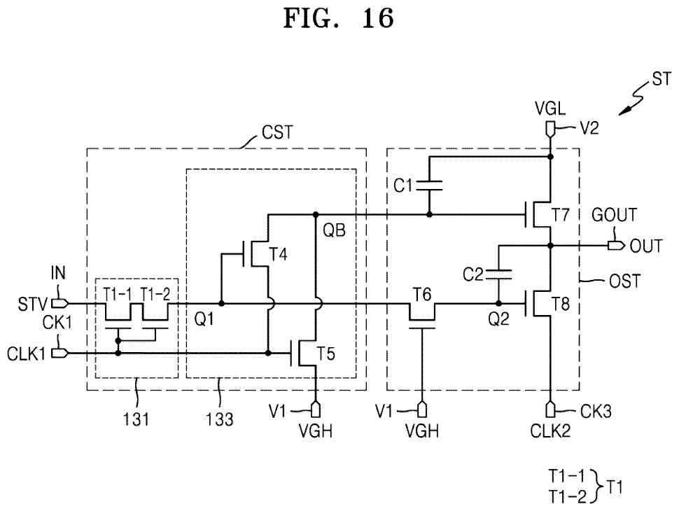

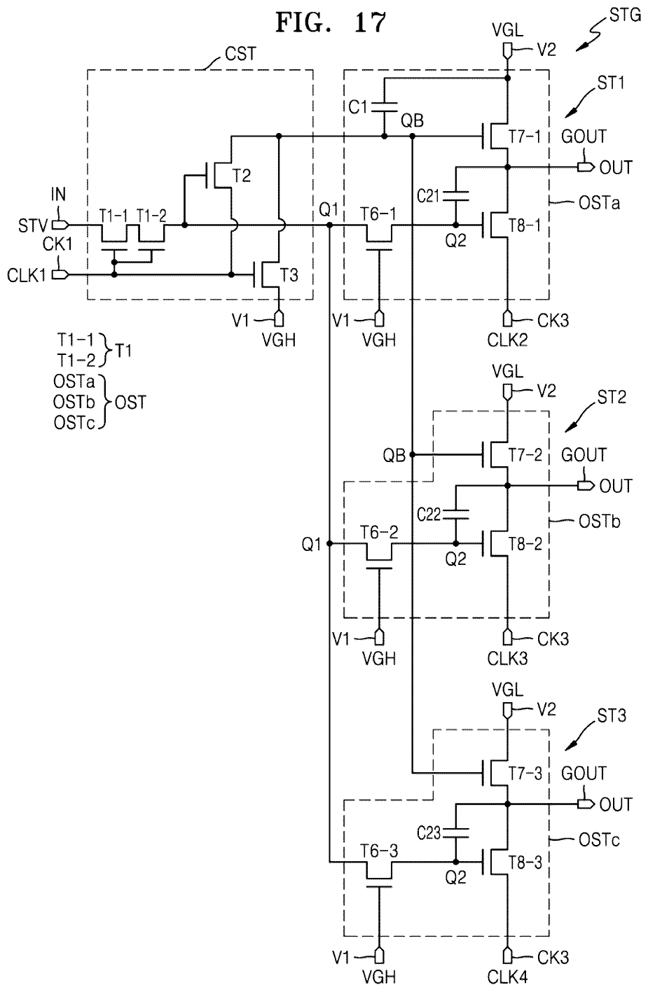

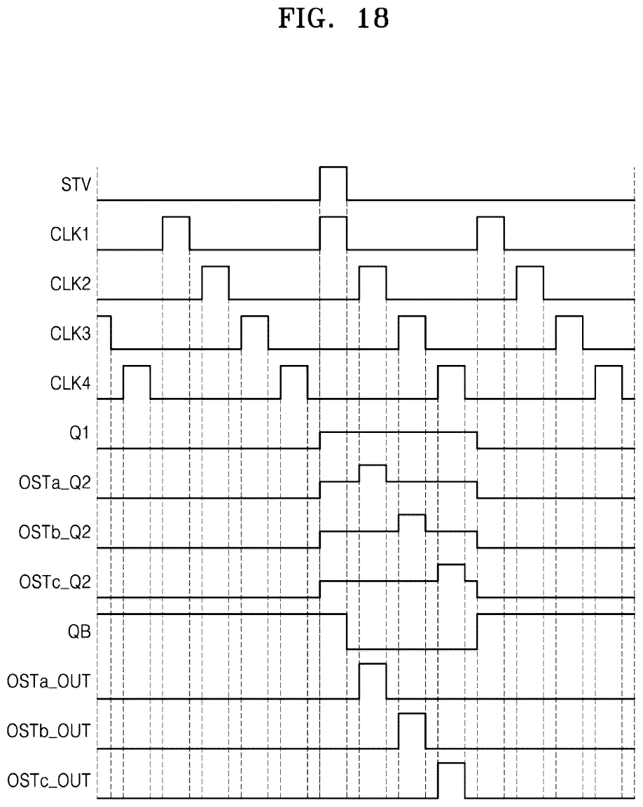

FIGS. 14 through 16 are views schematically illustrating a stage according to an embodiment. FIG. 17 is a view schematically illustrating a stage group according to an embodiment. FIG. 18 is a timing diagram for describing driving of a stage group including the stage of FIGS. 14 through 16. FIG. 17 illustrates an example of a stage group including the stage illustrated in FIG. 16.

As shown in FIGS. 14 through 16, the stage ST may include at least one N-channel transistor. The N-channel transistor may be an oxide transistor. The oxide transistor may include an oxide semiconductor, and the oxide semiconductor may be a zinc (Zn) oxide-based material, and may include Zn oxide, In—Zn oxide, Ga—In—Zn oxide, or the like. In some embodiments, the oxide semiconductor may be an indium (In)-gallium (Ga)—Zn-oxide (O) (IGZO) semiconductor. In some embodiments, the oxide semiconductor may be an In-tin (Sn)—Ga—Zn—O (ITGZO) semiconductor. For example, the silicon transistor may be a low temperature polycrystalline oxide (LTPO) thin-film transistor. A gate-on voltage of the N-channel transistor may be a high-level voltage and a gate-off voltage of the N-channel transistor may be a low-level voltage.

Since the stages ST shown in FIGS. 14 through 16 include at least one N-channel transistor, as shown in FIG. 18, the input signals and the output signals may be signals in which phases of the input signals and the output signals shown in FIG. 6 are changed by 180 degrees.

Referring to FIG. 18, each of the first clock signal CLK1, the second clock signal CLK2, the third clock signal CLK3, and the fourth clock signal CLK4 may have a shorter high-level duration than the low-level duration for one period. The output signals are shifted by a ¼ period of the clock signal and may be sequentially output.

Hereinafter, different configuration and driving from those of FIGS. 4, 11A, and 11B will be described, and a description of the same configuration and driving as those of FIGS. 4, 11A, and 11B will be omitted.

The first transistor T1 may be turned on when a clock signal input from the first clock terminal CK1 is at a high level, and may transmit the start signal STV input from the input terminal IN to the first node Q1. As shown in FIG. 16, the first transistor T1 may include a first sub-transistor T1-1 and a second sub-transistor T1-2 connected in series.

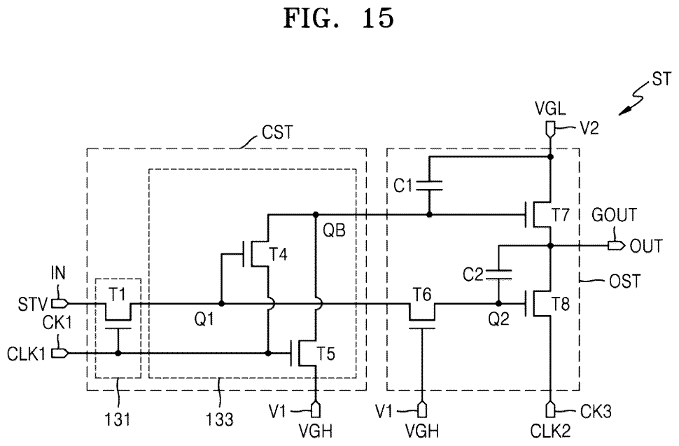

The second transistor T2 and the third transistor T3 may be connected between the second voltage input terminal V2 and the first node Q1. The second transistor T2 may be turned on when the voltage of the third node QB is at the high level, and the third transistor T3 may be turned on when the clock signal input from the second clock terminal CK2 is at the high level. The second transistor T2 and the third transistor T3, which are simultaneously turned on, may transmit the second voltage VGL, which is input from the second voltage input terminal V2, to the first node Q1. As shown in FIGS. 15 and 16, the second transistor T2 and the third transistor T3 may be omitted.

The fourth transistor T4 may be turned on when the voltage of the first node Q1 is at a high level, and may transmit the clock signal, which is input from the first clock terminal CK1, to the third node QB.

The fifth transistor T5 may be connected between the third node QB and the first voltage input terminal V1. The fifth transistor T5 may be turned on when a clock signal input from the first clock terminal CK1 is at a high level, and may transmit the first voltage VGH input from the first voltage input terminal V1 to the third node QB.

The first capacitor C1 may be connected between the second voltage input terminal V2 and the third node QB. As illustrated in FIG. 8, the first capacitor C1 may be omitted, or as illustrated in FIGS. 9 and 10, the first capacitor C1 may be disposed at one of a plurality of output stages OST that share the first node Q1 and the third node QB in the stage group STG. Alternatively, the first capacitor C1 may be disposed at each of a plurality of output stages OST.

The sixth transistor T6 may be turned on by the first voltage VGH input to the first voltage input terminal V1 and may transmit a signal from the first node Q1 to the second node Q2.

The seventh transistor T7 may be connected between the second voltage input terminal V2 and the output terminal GOUT. The seventh transistor T7 may be turned on when the voltage of the third node QB is at a high level, and may transmits the second voltage VGL that is a low-level voltage input from the second voltage input terminal V2 to the output terminal GOUT.

The eighth transistor T8 may be connected between the output terminal GOUT and the third clock terminal CK3. The eighth transistor T8 may be turned on when the voltage of the second node Q2 is at a high level, and may transmit the clock signal input from the third clock terminal CK3 to the output terminal GOUT.

The second capacitor C2 may be connected between the output terminal GOUT and the second node Q2.

FIG. 17 illustrates an example in which the first clock signal CLK1 is input to the first clock terminal CK1 of the control stage CST in the stage group STG, the second clock signal CLK2 is input to the third clock terminal CK3 of the first output stage OSTa, the third clock signal CLK3 is input to the third clock terminal CK3 of the second output stage OSTb, and the fourth clock signal CLK4 is input to the third clock terminal CK3 of the third output stage OSTC.

Referring to FIG. 18, a first output stage OSTa among the output stages OSTa, OSTb, and OSTc in the stage group STG of FIG. 17 may output the output signal OSTa_OUT synchronized with the high-level second clock signal CLK2 input from the third clock terminal CK3. The second output stage OSTb may output the high-level output signal OSTb_OUT synchronized with the third clock signal CLK3 input from the third clock terminal CK3. The third output stage OSTc may output the high-level output signal OSTc_OUT synchronized with the fourth clock signal CLK4 input from the third clock terminal CK3.

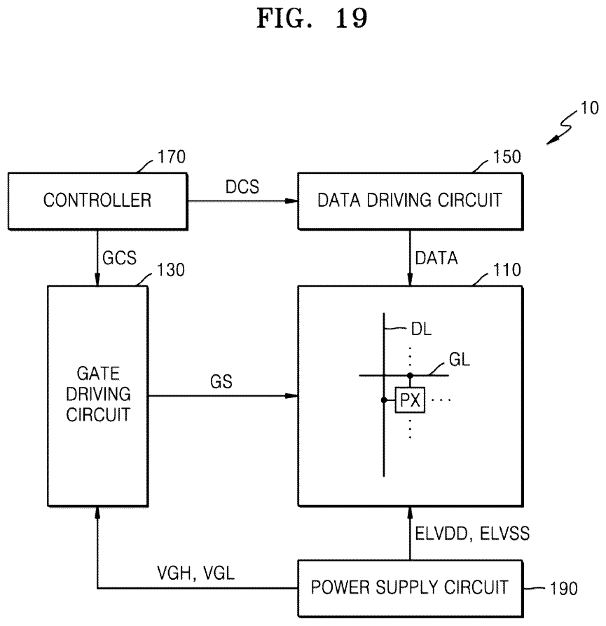

FIG. 19 is a view schematically illustrating a display device according to an embodiment.

A display device 10 is an apparatus for displaying a video or a still image, and may visually provide information to a user. The display device 10 may be applied to various products, such as mobile phones, smart phones, table personal computers (PCs), mobile communication terminals, electronic notes, electronic books, portable multimedia players (PMPs), navigation devices, ultra mobile PCs, televisions (TVs), laptop computers, monitors, billboards, Internet of Things (IoT) device, and the like.

The display device 10 according to an embodiment may be a display device such as an organic light emitting display device, an inorganic light emitting display (an inorganic light emitting display or an inorganic electroluminescent (EL) display device), or a quantum dot light emitting display.

Referring to FIG. 19, the display device 10 according to an embodiment may include a display panel 110. The display panel 110 may include a liquid crystal display panel, an organic light emitting display panel, or an inorganic light emitting display panel, and the type of the display panel 110 is not particularly limited. The display panel 110 may be a rigid type or a flexible type capable of rolling or folding.

A plurality of gate lines GL, a plurality of data lines DL, and a plurality of pixels PX connected to the plurality of gate lines GL and the plurality of data lines DL may be arranged in the display panel 110. An area in which the plurality of pixels PX are disposed may correspond to a display area for displaying an image.

The plurality of pixels PX may be repeatedly arranged in a first direction (an x-direction, a row-direction) and a second direction (a y-direction, a column-direction). The plurality of pixels PX may be arranged in various forms such as a stripe arrangement, a PenTile™ arrangement, a Diamond Pixel™ arrangement, a mosaic arrangement, and the like, and may implement images. Each of the plurality of pixels PX includes a display element, for example, an organic light emitting diode, and the organic light emitting diode may be connected to a pixel circuit. The pixel circuit may include a plurality of transistors and at least one capacitor. The pixel PX may emit, for example, red, green, blue, or white light through the organic light-emitting diode OLED. Each pixel PX may be connected to a corresponding one of the plurality of gate lines GL and a corresponding one of the plurality of data lines DL.

In an embodiment, a plurality of transistors included in the pixel circuit may be P-channel silicon transistors. In an embodiment, a plurality of transistors included in the pixel circuit may be N-channel oxide transistors. In an embodiment, some of the plurality of transistors included in the pixel circuit may be P-channel silicon transistors, and others may be N-channel oxide transistors.

Each of the gate lines GL may extend in the x direction (row direction) and may be connected to the pixels PX located in the same row. Each of the gate lines GL may transmit a gate signal to the pixels PX in the same row. Each of the data lines DL may extend in the y direction (column direction) and may be connected to the pixels PX located in the same column. Each of the data lines DL may transmit data signals to the pixels PX in the same column in synchronization with the gate signals.

Various conductive lines that transmit electrical signals to the display area, external driving circuits electrically connected to pixel circuits, and pads to which a printed circuit board or driver integrated circuit (IC) chip is attached may be located in a peripheral area (non-display area) outside the display area of the display panel 110. For example, a gate driving circuit 130, a data driving circuit 150, a controller 170, and a power supply circuit 190 may be provided in a peripheral area of the display panel 110.

The gate driving circuit 130 may be connected to the plurality of gate lines GL, may generate gate signals in response to a gate driving control signal GCS from the controller 170, and may supply the gate signals to the gate lines GL sequentially. The gate line GL may be connected to a gate of a transistor included in the pixel PX, and the gate signal GS may be a gate control signal that controls turn-on and turn-off of a transistor to which the gate line is connected. The gate signal GS may be signals including an on voltage at which the transistor may be turned on and an off voltage in which the transistor may be turned off. The gate driving circuit 130 may include a plurality of stages sequentially generating and outputting the gate signal GS.

The data driving circuit 150 may be connected to a plurality of data lines DL and may supply data signals to the data lines DL in response to a data driving control signal DCS from the controller 170. Data signal DATA supplied from the data line DL may be supplied to the pixel PX to which the gate signal is supplied. The data driving circuit 150 may convert input image data having a grayscale input from the controller 170 into a data signal DATA in the form of a voltage or current.

When the display device 10 is an organic light emitting display device, a first power voltage ELVDD and a second power voltage ELVSS may be supplied to the pixels PX of the display area. The first power voltage ELVDD may be a high-level voltage provided to one terminal of the driving transistor connected to a first electrode (a pixel electrode or an anode) of the organic light emitting diode of each pixel PX. The second power voltage ELVSS may be a low-level voltage provided to the second electrode (a counter electrode or a cathode) of the organic light emitting diode connected to the other terminal of the driving transistor. The first power voltage ELVDD and the second power voltage ELVSS may be driving voltages for emitting the plurality of pixels PX. The first power voltage ELVDD and the second power voltage ELVSS may be input from the controller 170 and/or the power supply circuit 190. FIG. 19 illustrates an example in which the first power voltage ELVDD and the second power voltage ELVSS are input from the power supply circuit 190.

The controller 170 may generate a gate driving control signal GCS and a data driving control signal DCS based on signals input from the outside. The controller 170 may supply the gate driving control signal GCS to the gate driving circuit 130, and supply the data driving control signal DCS to the data driving circuit 150. The gate driving control signal GCS may include a plurality of clock signals and a start signal. The gate driving control signal GCS may include a plurality of clock signals and a start signal. In an embodiment, the controller 170 may generate and supply a power driving control signal to the power supply circuit 190.

The power supply circuit 190 may generate signals (voltage and current) necessary for driving the pixels PX of the display panel 110 in response to the power driving control signal from the controller 170. The power supply circuit 190 may supply power to components of the electronic device. The power supply circuit 190 may include a power management integrated circuit (PMIC). The PMIC may supply optimized power to each component of the electronic device.

In an embodiment, the gate driving circuit 130, the data driving circuit 150, the controller 170, and the power supply circuit 190 may be mounted on the display panel 110 as a driving chip. The data driving circuit 150, the power supply circuit 190, and the controller 170 may be formed in the form of separate integrated circuit (IC) chips or one IC circuit chip and may be disposed on a flexible printed circuit board (FPCB) electrically connected to pads disposed at one side of the substrate. In another embodiment, the data driving circuit 150, the power supply circuit 190, and the controller 170 may be arranged on the substrate in a chip on glass (COG) or chip on plastic (COP) manner.

In an embodiment, a part or all of the gate driving circuit 130 may be directly formed in a peripheral area of the substrate during a process of forming a transistor constituting the pixel circuit in the display area of the substrate. The gate driving circuit 130 may include an amorphous silicon TFT gate driver circuit (ASG), a low temperature polycrystalline silicon (LTPS) TFT gate driver circuit, or an oxide semiconductor TFT gate driver circuit (OSG) internalized in the display panel 110.

In an embodiment, the gate driving circuit 130 may be implemented with the driving circuit DRV shown in FIG. 1. For example, the gate signal GS output by the gate driving circuit 130 to each gate line GL may correspond to the output signal OUT output from each of the output stages OST1 to OST3n of the plurality of stage groups STG of the driving circuit DRV to a signal line. Each of the output stages OST1 to OST3n may be connected to a gate line disposed in a corresponding row of the display panel 110. Each of the output stages OST1 to OST3n may generate a gate signal GS and output the gate signal to the connected gate line GL. That is, each of the output stages OST1 to OST3n may supply the gate signal GS to the gate line GL provided in the corresponding row.

A reference voltage (e.g., a first voltage VGH or a second voltage VGL), clock signals (e.g., a first clock signal CLK1, a second clock signal CLK2, a third clock signal CLK3, a fourth clock signal CLK4), and an external signal FLM, which are input to the stage groups STG, may be input from the controller 170 and/or the power supply circuit 190 shown in FIG. 19. In an embodiment, the first voltage VGH and the second voltage VGL, which are input to the stage groups STGs, may be input from the power supply circuit 190, and the external signal FLM, the first clock signal CLK1, the second clock signal CLK2, the third clock signal CLK3, and the fourth clock signal CLK4 may be input from the controller 170. In an embodiment, the first voltage VGH, the second voltage VGL, the first clock signal CLK1, the second clock signal CLK2, the third clock signal CLK3, the fourth clock signal CLK4, and the external signal FLM may be input from the controller 170. In an embodiment, the first voltage VGH, the second voltage VGL, the first clock signal CLK1, the second clock signal CLK2, the third clock signal CLK3, the fourth clock signal CLK4, and the external signal FLM may be input from the power supply circuit 190.

The number of stages and the number of output stages constituting the gate driving circuit 130 to which the driving circuit DRV according to an embodiment of the present invention is applied, may be variously modified according to the number of rows (horizontal lines) provided in the display panel 110.

In an embodiment, the electronic device may output various information through the display device 10 within the operating system. When the processor executes an application stored in the memory, the display device 10 may provide application information to the user through the display panel.

The electronic device of the disclosure may be various types of devices. The electronic device may include, for example, at least one of a portable communication device (e.g., a smartphone), a computer device, a portable multimedia device, a portable medical device, a camera, a wearable device, or a home appliance. An electronic device according to an embodiment of the disclosure is not limited to the above-described devices.

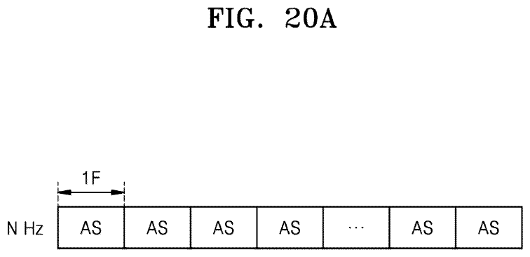

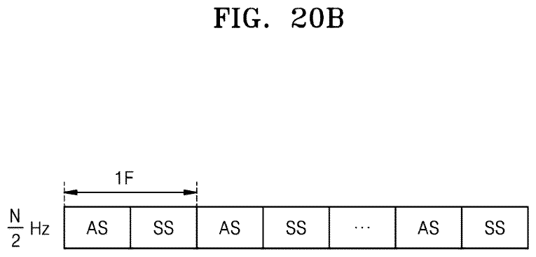

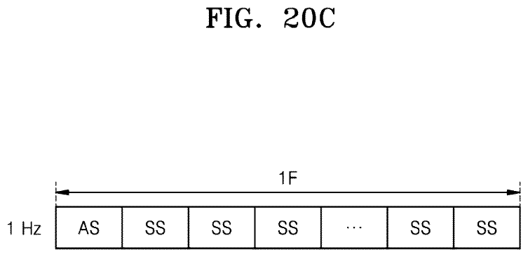

FIGS. 20A through 20C are conceptual views for describing a driving method of a display device according to a driving frequency.

In an embodiment, the display device 10 may support a variable refresh rate (VRR). The refresh rate is a frequency at which a data signal is substantially written to a driving transistor of a pixel PX, and may represent a screen scanning rate, a screen refresh rate, and the number of image frames played in one second. In an embodiment, the refresh rate may be an output frequency of the gate driving circuit 130 and/or the data driving circuit 150. A frequency corresponding to the refresh rate may be a driving frequency. The display device 10 may adjust an output frequency of the gate driving circuit 130 and an output frequency of the data driving circuit 150 according to the driving frequency. The display device 10 that supports a VRR may operate while changing the driving frequency in the range of a maximum driving frequency and a minimum driving frequency. For example, when the refresh rate is about 120 Hz, a gate signal supplied to each horizontal line (row) may be output while being synchronized with timing at which a data signal is written at 120 times per second. The display device 10 may display an image while changing the driving frequency according to the refresh rate.

Depending on the driving frequency, one frame 1F may include a first scan period AS only, or a first scan period AS and one or more second scan periods SS. For example, as shown in FIG. 20A, in the display device 10 that operates with the driving frequency of N Hz, one frame 1F may include one first scan period AS, where N is an integer greater than 1. As shown in FIG. 20B, in the display device 10 that operates with the driving frequency of N/2 Hz, one frame 1F may include one first scan period AS and one second scan period SS. As shown in FIG. 20C, in the display device 10 that operates with the driving frequency of 1 Hz, one frame 1F may include one first scan period AS and N-1 second scan periods SS. The lower the driving frequency, the longer one frame 1F may be. The length of the second scan period SS may be equal to or shorter than the length of the first scan period AS.

The first scan period AS may be defined as an address scan period in which a data signal is written in the pixel PX in response to a gate signal for turning on a write transistor in the pixel PX, and the pixel emits light with a luminance corresponding to the written data signal. An operation in which the data signal is written from the data line DL to the pixel PX may also be referred to as a data programming operation.

The second scan period SS may be defined as a self-scan period in which a data signal is not written in the pixel PX by a gate signal for turning off the write transistor of the pixel PX. During the second scan period SS, the data signal written and stored in the first scan period AS is maintained in the pixel PX, and the pixel may emit light with a luminance corresponding to the data signal written in the first scan period AS.

In an embodiment of the disclosure, when a predetermined signal is input (supplied) to the device, the signal may be supplied with the gate-on voltage, and when a predetermined signal is not input (supplied) to the device, the signal may be supplied with the gate-off voltage. For example, in FIG. 4, the previous output signal OUT′ is supplied may mean that the previous output signal OUT′ is input as a low-level voltage, and the previous output signal OUT′ is not supplied may mean that the previous output signal OUT is input as a high-level voltage. For example, in FIG. 4, the previous output signal OUT′ is supplied may mean that the previous output signal OUT′ is input as a high-level voltage, and the previous output signal OUT′ is not supplied may mean that the previous output signal OUT is input as a low-level voltage.

According to embodiments of the disclosure, a plurality of output stages may share nodes (e.g., a first node Q1 and a third node QB), thereby sharing a control stage for controlling voltages of the nodes. According to embodiments of the disclosure, one control stage may share two or more output stages so that the area of a driving circuit can be reduced and thus a dead space of a display device can be minimized.

The control stage shared by two or more output stages may include at least one transistor (e.g., a first transistor T1) in which a clock signal is input to a gate. One control stage may share two or more output stages so that parasitic capacitance due to a clock signal at an input terminal can be reduced. Thus, since the gate signal may be stably output, the reliability of the circuit can be maintained and the power consumption of the display device can be reduced.

According to an embodiment of the disclosure, a driving circuit configured with a small number of circuit elements to stably output gate signals while reducing the area of a non-display area, and a display device and an electronic device including the driving circuit can be provided. The effects of the disclosure are not limited to the above-described effects, and may be variously extended without departing from the spirit of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A driving circuit comprising a plurality of stage groups, each of the plurality of stage groups comprising:
a control stage; and
a plurality of output stages connected to the control stage,
wherein the control stage is connected to a first terminal which supplies a first voltage and a second terminal which supplies a second voltage having a different level from a level of the first voltage, and is configured to control voltages of a first node and a second node,
wherein each of the plurality of output stages is connected to the first node, and the second node to share the control stage, and is configured to output an output signal through an output terminal according to the voltages of the first node and the second node,
wherein the control stage comprises a first transistor connected to an input terminal which supplies a start signal and the first node, and having a gate connected to a first clock terminal which supplies one of a plurality of clock signals, and
wherein each of the plurality of output stages comprises:
a second transistor connected to the first node and a third node, and having a gate connected to the second terminal; and
a third transistor connected to the output terminal and a second clock terminal which supplies another one of the plurality of clock signals, and having a gate connected to the third node.

2. The driving circuit of claim 1, wherein each of the output stages further comprises:
a fourth transistor connected to the first terminal and the output terminal, and having a gate connected to the second node;
a first capacitor connected to the output terminal and the third node; and
a second capacitor connected to the first terminal and the second node.

3. The driving circuit of claim 1, wherein each of the plurality of output stages further comprises:
a fourth transistor connected to the first terminal and the output terminal, and having a gate connected to the second node; and
a first capacitor connected to the output terminal and the third node, and
wherein at least one of the output stages further comprises a second capacitor connected to the first terminal and the second node.

4. The driving circuit of claim 1, wherein, each of the plurality of clock signals swings between a first level voltage and a second level voltage which alternate with each other, and
wherein, when a number of the plurality of output stages is m−1, the plurality of clock signals comprise first through m-th clock signals which are phase-shifted by a 1/m period, where the m is a positive integer of 3 or more, and
wherein a clock signal input from the second clock terminal comprises one of the plurality of clock signals other than a clock signal input from the first clock terminal among the first through m-th clock signals, and clock signals input from second clock terminals of m−1 output stages are sequentially phase-shifted by a 1/m period.

5. The driving circuit of claim 4, wherein the control stage further comprises:
a fifth transistor connected to the first terminal and the first node, and having a gate connected to the second node;
a sixth transistor connected to the fifth transistor and the first node, and having a gate connected to a third clock terminal which supplies one of the plurality of clock signals;
a seventh transistor connected to the second node and the first clock terminal, and having a gate connected to the first node; and
an eighth transistor connected to the second node and the second terminal, and having a gate connected to the first clock terminal, and
wherein a clock signal input from the third clock terminal comprises one of the plurality of clock signals other than a clock signal input from the first clock terminal among the first through m-th clock signals.

6. The driving circuit of claim 5, wherein one of the plurality of clock signals input from second clock terminals of the m−1 output stages and the clock signal input from the third clock terminal are same.

7. The driving circuit of claim 1, wherein the start signal comprises an external signal or an output signal output from a last output stage of a previous stage group.

8. The driving circuit of claim 1, wherein, while output signals of a first level are sequentially output from the plurality of output stages, a voltage of the second node is a voltage of a second level in which the first level is inverted.

9. The driving circuit of claim 1, wherein the second voltage is a voltage lower than the first voltage, and transistors included in the control stage and the output stages comprise P-channel transistors.

10. The driving circuit of claim 1, wherein the second voltage is a voltage higher than the first voltage, and transistors included in the control stage and the output stages comprise N-channel transistors.

11. A driving circuit comprising a plurality of stage groups, each of the plurality of stage groups comprising:
a control stage; and
at least two output stages connected to the control stage,
wherein the control stage is connected to an input terminal which supplies a start signal, a first clock terminal which supplies a first clock signal among a plurality of clock signals, a first terminal which supplies a first voltage, and a second terminal which supplies a second voltage having a different level from a level of the first voltage, and is configured to control voltages of a first node and a second node in response to the start signal and the first clock signal, and
wherein each of the at least two output stages is connected to the first terminal and a second clock terminal which supplies a second clock signal among the plurality of clock signals, and is connected to the first node and the second node to output an output signal of a first level or a second level according to the voltages of the first node and the second node,
wherein, in each of the plurality of clock signals, a first level voltage and a second level voltage lower than the first level voltage alternate with each other,
wherein, when a number of the at least two output stages is m−1, the plurality of clock signals comprise m clock signals which are phase-shifted by a 1/m period, where the m comprises a positive integer of 3 or more,
wherein the first clock signal is one of the m clock signals and the second clock signal is one of the m clock signals other than the first clock signal among the m clock signals, and
wherein second clock signals input from m−1 output stages are sequentially phase-shifted by a 1/m period.

12. The driving circuit of claim 11, wherein the control stage comprises a first transistor connected to the input terminal and the first node, and having a gate connected to the first clock terminal.

13. The driving circuit of claim 12, wherein each of the at least two output stages comprises:
a second transistor connected to the first node and a third node, and having a gate connected to the second terminal; and
a third transistor connected to an output terminal outputting the output signal and the second clock terminal, and having a gate connected to the third node.

14. The driving circuit of claim 13, wherein each of the at least two output stages further comprises:
a fourth transistor connected to the first terminal and the output terminal, and having a gate connected to the second node;
a first capacitor connected to the output terminal and the third node; and
a second capacitor connected to the first terminal and the second node.

15. The driving circuit of claim 13, wherein each of the at least two output stages further comprises:
a fourth transistor connected to the first terminal and the output terminal, and having a gate connected to the second node; and
a first capacitor connected to the output terminal and the third node, and
wherein one of the at least two output stages further comprises a second capacitor connected to the first terminal and the second node.

16. The driving circuit of claim 11, wherein the control stage comprises:
a fifth transistor connected to the first terminal and the first node, and having a gate connected to the second node;
a sixth transistor connected to the fifth transistor and the first node, and having a gate connected to a third clock terminal which supplies a third clock signal of the plurality of clock signals;
a seventh transistor connected to the second node and the first clock terminal, and having a gate connected to the first node; and
an eighth transistor connected to the second node and the second terminal, and having a gate connected to the first clock terminal,
wherein the third clock signal is one of the m clock signals other than the first clock signal among the m clock signals, and
wherein one of third clock signals input from the m−1 output stages and the second clock signal are same.

17. An electronic device comprising:
a controller configured to output a plurality of clock signals;
a power supply circuit configured to output a reference voltage; and
a driving circuit configured to output gate signals based on the plurality of clock signals and the reference voltage,
wherein the driving circuit comprises a plurality of stage groups,
wherein each of the plurality of stage groups comprises a control stage and a plurality of output stages connected to the control stage,
wherein the control stage is connected to a first terminal which supplies a first voltage and a second terminal which supplies a second voltage having a different level from a level of the first voltage, and is configured to control voltages of a first node and a second node,
wherein each of the plurality of output stages is connected to the first node, and the second node to share the control stage, and is configured to output the gate signals through an output terminal according to the voltages of the first node and the second node,
wherein the control stage comprises a first transistor connected to an input terminal which supplies a start signal and the first node, and having a gate connected to a first clock terminal which supplies one of the plurality of clock signals, and
wherein each of the plurality of output stages comprises:
a second transistor connected to the first node and a third node, and having a gate connected to the second terminal; and
a third transistor connected to the output terminal and a second clock terminal which supplies another one of the plurality of clock signals, and having a gate connected to the third node.

18. The electronic device of claim 17, wherein each of the output stages further comprises:
a fourth transistor connected to the first terminal and the output terminal, and having a gate connected to the second node;
a first capacitor connected to the output terminal and the third node; and
a second capacitor connected to the first terminal and the second node.

19. The electronic device of claim 17, wherein each of the plurality of output stages further comprises:
a fourth transistor connected to the first terminal and the output terminal, and having a gate connected to the second node; and
a first capacitor connected to the output terminal and the third node, and
wherein at least one of the output stages further comprises a second capacitor connected to the first terminal and the second node.

20. The electronic device of claim 17, wherein, each of the plurality of clock signals swings between a first level voltage and a second level voltage which alternate with each other, and,
wherein, when a number of the plurality of output stages is m−1, the plurality of clock signals comprise first through m-th clock signals which are phase-shifted by a 1/m period, where the m is a positive integer of 3 or more.
